(19) United States
(12) Patent Application Publication
(10) Pub. No.: US 2010/0256269 A1
(43) Pub. Date: Oct. 7, 2010

(54) NICKEL INCORPORATION INTO LDH CHLOROBENZENESULFONATE

(76) Inventors: Paul S. Braterman, Glasgow (GB); Nandika D'Souza, Denton, TX (US)

Correspondence Address: JACKSON WALKER LLP, 901 MAIN STREET, SUITE 6000, DALLAS, TX, 75202-3797, US

(21) Appl. No.: 12/664,030

(22) PCT Filed: Jul. 2, 2008
(86) PCT No.: PCT/US08/08286

§ 371 Date: May 17, 2010

Related U.S. Application Data
(60) Provisional application No. 60/958,417, filed on Jul. 5, 2007.

(51) Int. Cl. C09K 21/14; C09K 21/02; C08K 5/42; C08K 5/41

(52) U.S. Cl. 524/156; 252/609; 524/157

(57) ABSTRACT

Composition and method of preparation for layered double hydroxides (LDHs) with specific anions, such as those derived from sulfanilic acid, p-toluenesulfonic acid, or 4-chlorobenzenesulfonic acid. LDHs may also be altered by doping them with nickel to replace a fraction of the divalent metal present. Nickel-doped LDHs with exchanged anion composition may be useful as flame retardants, among many other possible uses including as antacids, drug-delivery systems, modified electrodes, polymer stabilizers, adsorbents, electro-photoactive materials, and catalysts or catalyst precursors.

This application claims priority to U.S. Provisional Patent Application Ser. No. 60/958,417, entitled “NICKEL INCORPORATION INTO LDH CHLOROBENZENESULFONATE” filed on Jul. 5, 2007, the entire content of which is hereby incorporated by reference.

### STATEMENT OF RIGHTS TO INVENTIONS MADE UNDER FEDERALLY SPONSORED RESEARCH

This invention was made in part during work supported by a grant from the NIST (#70NANB5H1021, to J. Gillman, entitled Flame Retardant Nonocomposites with Layer Double Hydroxides). The government may have certain rights in the invention.

### BACKGROUND

The present invention relates to a flame resistant material, more specifically, it relates to the preparation and composition of layered double hydroxides (LDHs) with specific anions, such as anions derived from sulfanilic acid, p-toluenesulfonic acid, or 4-chlorobenzenesulfonic acid. In a preferred embodiment of the invention, these LDHs with specific ions may also be altered by doping them with nickel to replace a fraction of the divalent metal present.

LDH are anion-exchanging materials, and this is one of their many practical uses. Other practical uses include, but are nowhere limited to LDH as antacids, drug-delivery systems, modified electrodes, polymer stabilizers, flame retardants, adsorbents, electro-photoactive materials, and catalysts/catalyst precursors.

Layered double hydroxides (LDHs) are a group of anion-exchanging materials containing mixed-metal hydroxide layers structurally related to brucite, Mg(OH)₂, and other divalent metal hydroxides. By replacing some of the divalent cations with trivalent cations (M³⁺: Al, Fe, Cr, etc.), a net positive charge develops on the hydroxide layers. These positive charges are balanced by exchangeable anions, which reside within the interlayer spaces and on the surface layers and outer edges. Along with the anions, water molecules are commonly found within the interlayer and on the outer edges and surface.

### General Description of LDHs

Layered double hydroxides (LDH) are a class of natural and synthetic mixed-metal hydroxides, historically described as anion-exchanging, clay-like materials, hydrotalcite-like materials, or anionic (i.e. anion-exchanging) clays. LDH are structurally related to brucite, Mg(OH)2, with one principal notable difference: LDH are mixed-metal hydroxides and brucite is a magnesium hydroxide. The most commonly studied LDH consists of divalent and trivalent metals (M), with the general formula:

[M^{(II)}₁₋ₓM^{(III)}ₓ(OH)₂]^{x+}(A^{m-})_{x/m}.nH₂O

wherein counter-anion A^{m-} represents the exchangeable anion, such as NO₃⁻, Cl⁻, CO₃²⁻, SO₄²⁻ and various organic carboxylates, sulfates and sulfonates. In fact, there are no known constraints other than geometry on the identity of A^{m-}, although some anions are more readily inserted than others.

The divalent cation, M^{(II)}, could be any ion with a radius that is reasonably similar to Mg²⁺. Examples of possible divalent cations include Ni²⁺, Co²⁺, Zn²⁺, Fe²⁺, Mn²⁺, Cu²⁺, Ti²⁺, Cd²⁺, Pd²⁺, and Ca²⁺. The trivalent cation, M^{(III)}, could be any ion with a radius that is reasonably similar to Al³⁺. Examples of possible trivalent ions include Al³⁺, Ga³⁺, Fe³⁺, Cr³⁺, Mn³⁺, Co³⁺, V³⁺, In³⁺, Y³⁺, La³⁺, Rh³⁺, Ru³⁺, and Sc³⁺.

Here x is the fraction of M^{(II)} in M(OH)₂ replaced by M^{(III)}, m is the charge on the anion (which can take any whole number value but is usually in the range from 1 to 4, unless the anion is polymeric), and n is the number of molecules of water per M(OH)₂ unit. Usually, x is in the range from around 0.25 to 0.33, although higher and lower values have been reported in a range of approximately 0.15 to 0.5. The value of n is dependent on material and conditions, generally in the range from 0 to 4, and is typically around 1.5 or 2.

In whole number proportions, these two formulas transform into M^{(II)}₂M^{(III)}(OH)₆A_{1/m}.nH₂O and M^{(II)}₃M^{(III)}(OH)₈A_{1/m}.nH₂O, which are simplified as either a 2:1 LDH or a 3:1 LDH, respectively. The value for n will be a positive number or zero, dependent on the anion and conditions, with two being common.

The values for the counter-anion (A) depend on the charge of the anion, with respect to the amount of trivalent metal, such that the 1/m term achieves charge neutrality throughout the LDH structure.

The above general formula in no way exhausts the possible chemical makeup of LDH as a whole. LDH have been synthesized using monovalent-trivalent metals, commonly in the form of a LiAl₂ hydroxide, and with more than two types of metals within the metal hydroxide framework.

In a preferred embodiment of the current invention, LDH containing Mg or Zn, for the divalent metals, and Al for the trivalent metal, have been prepared by the anion exchange of nitrate with para-chlorobenzenesulfonate (CBS), sulfanilate, or para-toluenesulfonate. The subsequent LDH-CBS was blended into poly(ethylene terephthalate), PET, in which the thermal stabilities and flame retardant properties were studied.

Along with these materials, small amounts of free nickel cations have been successfully adsorbed onto the surface and outer edges of the layers of LDH-CBS and other materials studied, or incorporated into the bulk of the layers, depending on the procedure used. These nickel-loaded materials were prepared and studied in order to compare or contrast the known catalytic abilities of nickel, with the corresponding materials with no nickel incorporated, and in particular to observe the resultant changes in the properties and especially thermal properties and heat resistance of LDH-CBS-.PET and related composites.

Comparison with Brucite

LDH and brucite are similar, in that both exist by having sheet-like morphologies, in which the sheets grow in two dimensions (x,y plane). In both cases, each metal cation is directly bonded to six hydroxide groups and each hydroxide group is directly bonded to three metals. From a bonding perspective, each metal cation has a coordination number of six and each oxygen atom has a coordination number of four, except at the edges of the lattice sheets.

One difference between brucite and LDH is that the metal hydroxide framework is nearly planar, in brucite, but not necessarily so with LDH. The types of metals used for LDH will have different metal-oxygen bond distances. These bond distance differences can result in a slightly corrugated lattice framework. The essential difference between LDH and brucite is the development of a net positive charge on the lattice sheets due to the substitution of some of the magnesium cations with trivalent cations. It is this net positive charge that makes LDH extremely efficient with anionic uptake, such that the basic descriptive definition has been as anion-exchanging clays for several decades.

It is important to note that LDH exists both naturally and synthetically, where the most common naturally occurring LDH is a mineral, known as hydrotalcite. Hydrotalcite is a Mg₃Al-hydroxycarbonate with the formula: Mg₆Al₂(OH)₁₆CO₃.2H₂O. All other types of LDH, having a similar formula, are sometimes referred to as hydrotalcite-like compounds.

### LDH Environment

The positively charged LDH layers are stacked on top of one another, in a vertical fashion, typically giving rise to what crystallographers describe as rhombohedral stacking, although hexagonal and less regular stacking sequences are also known. The counter-anions and water molecules are located between each adjacent layer and on the outer layer's surface and edges. Anions that are between adjacent LDH layers, are termed intercalated, and anions on the edges and surfaces of the LDH layers are termed adsorbed.

The actual LDH layers commonly stack on top of one another by a three-layer sequence. Each layer has the M(OH)₆ structures positioned in an arrangement approximating the D_{3d} point group, such that the top three hydroxides will be out-of-phase with the bottom three hydroxides.

There are numerous possibilities of such three-layer sequencing, depending among other things on whether the top layer forms a prismatic structure with the nearest bottom layer (denoted as P-type) or whether the top layer forms an antiprismatic structure with the nearest bottom layer (denoted as O-type).

Some examples of three-layer sequencing possibilities include the 3R (three-layer, rhombohedral) and 2H (two-layer, hexagonal) polytypes. The common convention in the absence of contrary evidence is to assume an ABC stacking sequence. The many different polytypes arise from the relationships between the inter- and intra-layer ABC patterns, with the added possibility of disordered layer stacking.

There is no direct contact between the trivalent metal (where the net positive charge would be located) and the counter-anion, but rather a longer range electrostatic attraction together with hydrogen bonding by the pendant lattice hydroxide and the counter-anion (hereafter described as just the anion). Water molecules also exist between the lattice sheets, and are also not only hydrogen-bonded to the pendant lattice hydroxides, but to each other and the anions. In this regard, once charge neutrality is satisfied, hydrogen-bonding is the most important kind of bonding interaction in LDH.

The metals within the lattice framework for an ideal divalent/trivalent LDH are positioned in such a way that the trivalent metal cations cannot be adjacent to one another.

This positioning of the trivalent cations is similar to Lowenstein's rule for the aluminosilicates, which in both cases, are undoubtedly related to Pauling's adjacent charge principle. For every trivalent metal cation in LDH, a partial positive charge will be found in that area. Keeping the trivalent metal cations positioned away from one another ensures that the positive charges will not be localized but spread throughout the lattice sheets. This “delocalization” of positive charges is very important for anionic uptake, in that it keeps the charge-balancing anions from aggregating together in just one area.

One important topic for LDH, with respect to anionic uptake, is charge density. Due to the net positive charge development within the LDH sheets, the unit charge per area can be used to show the potential amounts of anions that LDH with various divalent to trivalent metal ratios can incorporate (relative to one another). The formula for calculating charge density (C_{d}):

C_{d}=xe/(a² sin 60°) or for a typical value of a, C_{d}=12.0xe/nm²

The variables in this formula correspond to: x is the ratio of the trivalent metal to the total metals amount, a is the distance between adjacent metal ions in the layer, e is the electronic charge and sin 60° is a geometrical factor describing the angle between the a and b axes.

For example, a 2:1 Mg—Al LDH and a 3:1 Mg—Al LDH should have different charge densities, simply based of the different values for x. Using the simplified formula, the 3:1 Mg—Al LDH has a trivalent metal to total metals amount of 1/4, and the 2:1 Mg—Al LDH has a trivalent metal to total metals amount of 1/3. One can easily calculate charge densities of 4.0 e/nm² for a 2:1 Mg—Al LDH and 3.0 e/nm² for a 3:1 Mg—Al LDH. The importance of this formula should now be clear; a 2:1 Mg—Al LDH has more positive charge, per unit area, and should then be capable of more anionic incorporation. Although the above calculation was done for a Mg—Al LDH, the charge density formula should produce similar results for other divalent-trivalent metal arrangements. Only the lattice parameter, a, will be different (but not greatly different) than in the Mg—Al LDH materials.

### LDH History

The earliest records show that the naturally occurring mineral of LDH was discovered in Sweden, back in 1842. LDH have been known as mixed-metal hydroxides since the early 20^{th} century, but the initial attempts to describe their structure were not correct.

The early investigators noticed differences in the pH of controlled precipitations of mixtures of magnesium and aluminum compounds, by alkali, with respect to both magnesium hydroxide and aluminum hydroxide. Undoubtedly, without the invention of the pH meter some time earlier, these investigators would not have made such profound observations. The early investigators, knowing that they had obtained something unique, described their product as either a surface adsorption complex or as an alternation of Mg(OH)₂ and Al(OH)₃ compounds.

It was not until the 1960s that x-ray diffraction shed some insight about this unique material. The x-ray diffraction pattern of the mineral, hydrotalcite, was already known, so by comparison with this synthesized material, the relationship was identified. This ultimately led to the synonym, hydrotalcite-like compounds or the evolved layered double hydroxides, or the less widely used, double layered hydroxides. Throughout the remainder of the 20^{th} century, and up to this day, powder x-ray diffraction remains an integral characterization technique for any synthesized LDH.

### Practical Uses for LDH

As previously mentioned, LDH are anion-exchanging materials, by nature. This has remained their primary practical use, and the types of anions that have been investigated with LDH constitute the vast majority of articles published. Since so many types of anions have been explored, there should be an order of preference, based on the anion's size, charge, electronegativity, etc. Back in the 1970s-1980s, a ground-breaking survey on anionic preference was accomplished. This survey showed that, of the simple inorganic and organic anions, carbonate is the easiest to intercalate and the most difficult to exchange within LDH. On the opposite end, the halides and nitrate are just as easy to intercalate but the easiest to exchange. Most, if not all of the other anions lie between these two extremes. As a result, for typical anion exchange, most LDH materials are prepared with chloride or nitrate as the initial anion, then replaced with whatever anion is desired. The key to anion exchange is to never start out with carbonate because it is too difficult to replace by other anions except under some circumstances in the presence of acid (carbonate has been shown to be exchanged with chloride during a dilute HCl(aq)/concentrated NaCl workup of 2:1 Mg—Al and Zn—Al LDH materials).

Other practical uses include, but are nowhere limited to LDH as antacids, drug-delivery systems, modified electrodes, polymer stabilizers, flame retardants, adsorbents, electro-photoactive materials, and catalysts/catalyst precursors. There is no doubt that with time, many more will be discovered.

### Preparation of LDH

Just as there are many practical applications for LDH, there are many ways for their synthesis. The most common procedure is by the precipitation of an aqueous solution of the divalent/trivalent metal salts with a base (NaOH or NH₄OH). Within this procedure, there are two routes: By the addition of the base to the metal salts solution (variable pH or direct precipitation method) or by the co-addition of the base and metal salts solution, such that a constant pH is held (constant pH or coprecipitation method).

In the addition of the base to the metal salts route, the metal with the lowest solubility, in terms of hydroxide formation, usually will precipitate out first (exceptions have been shown with LDH containing Cr(III)). In the case of a Mg:Al LDH, the aluminum will precipitate out, as aluminum hydroxide, while the magnesiums will remain in solution (equation 1). It is not clear what happens next, when more additions of base are added. It is possible that further hydroxide additions will result in incorporation of magnesium and hydroxide ions (equation 2) or in an aluminum hydroxide complex ([Al(OH)₄]⁻, aluminate), which will then take in the available magnesium ions (equation 3):

2Mg²⁺+Al³⁺+3OH⁻→Al(OH)₃(s)+2Mg²⁺ (1)

2Mg²⁺+Al(OH)₃(s)+3OH⁻→[Mg₂Al(OH)₆]⁺ (2)

or

2Mg²⁺+Al(OH)₃(s)+3OH⁻→[Al(OH)₄]⁻+2OH⁻+2Mg²⁺→[Mg₂Al(OH)₆]⁺ (3)

In the above equations, water molecules are left out, for simplicity, and the LDH would also precipitate out as a white solid (but with an appropriate counter-anion. In either case for equations 2 or 3, the leading theory holds that the aluminum hydroxide solid will undergo some sort of dissolution or modification in order to accommodate six hydroxides, to be shared with neighboring magnesiums.

Titration curves have proven to be helpful when using the variable pH route for LDH synthesis. In the case of a 2:1 Mg—Al LDH, the generated titration curve can be broken down into three main regions of interest. When the magnesium and aluminum salts are dissolved in water, the pH of the solution is usually around 3.5-3.8, if enough of the metal salts are used for the preparation of 1.0 g of LDH. This low pH range is indicative of the acidic properties, inherent in aqueous aluminum. When the first additions of base are added, the aluminum ions will precipitate out first (region 1), until three molar amounts of hydroxide are added. When this stoichiometric amount is reached, all aluminum exists in the solid hydroxide form (region 2). Further additions of hydroxide result in the formation of the LDH (region 3). FIG. 1 shows a generated titration curve of a 2:1 Mg—Al LDH-Cl. Different LDH will show different curves, but in many cases similar features will be present.

The generation of complete accurate titration curves for a 2:1 Mg—Al LDH-A (A=chloride, nitrate or carbonate) takes several hours. The pH values for the formation of aluminum hydroxide, from each NaOH addition, equilibrates rapidly, but during the LDH formation, the pH values spike up rapidly, decline rapidly, then slowly equilibrate.

This observation may be evidence of the complex mechanism of LDH formation, from equations 1-3, but is not enough to assume an aluminate intermediate. There is no doubt that the rise, then drop in pH values are due to the incorporation of hydroxide into the forming LDH structure.

From the titration curve, the aluminum will begin precipitating out at pH values far from the neutral 7.00 mark and show a gradual increase in pH (1). Once the three molar stoichiometric amount of NaOH is added, the curve will sharply increase up to the neutral pH mark (2).

After point (2) is reached, further hydroxide additions result in another fairly smooth increase in pH values (3). The end point of the titration shows a basic material with a pH above the neutral 7.00 mark.

The purpose of staring out with a 3:1 molar ratio of magnesium to aluminum is to use the excess magnesium as a buffer. The excess magnesium will ensure that the overall precipitation pH will be lower than that with a stoichiometric amount. This is useful because a lower pH will mean less uptake of carbon dioxide and any unreacted hydroxides (beyond the stoichiometric amount) will not get incorporated into the LDH. However, this use of excess magnesium is optional.

When generating titration curves for LDH containing both acidic divalent and trivalent metals, the pH values for these three regions will be considerably lower than that for the magnesium and aluminum case. For instance, a 2:1 Co—Al LDH-Cl would have its initial pH around 3.1-3.2, its equivalence point pH around 4.2-4.5, and its endpoint pH is around 5.5-5.6.

Other, less common techniques include preparation by both divalent and trivalent (hydr)oxides with anion, preparation from metals, the so-called aluminate route, sol-gel techniques, homogeneous precipitation and preparation by intentional oxidation.

Some key points for successful divalent-trivalent metal LDH synthesis:
The metal cations should all conform to being in a six-coordinate environment (D_{3d} symmetry).
The selected anion should not interfere with the LDH lattice formation by precipitation with any of the LDH lattice metals (Kₛₚ issues).
Metal ions that are easily reduced/oxidized should be handled differently.
Unwarranted or adventitious carbon dioxide should be excluded from the reaction vessel if LDH-CO₃ is not the desired material, especially if the LDH is basic.

In all of the above techniques, the most important considerations to make when preparing LDH are that the metals ratio and the amount of base ultimately dictate which form will be produced. Also of note, depending on the types of metals, some LDH materials will be more basic and some will be less basic.

### Post-Synthesis Treatment

After the LDH precipitate has been prepared, there are two main techniques for post-treatment. The most common post-treatment technique is to subject the newly formed precipitate to gentle reflux, in its own mother liquor. The reflux is performed under a stream of inert gas, in order to avoid adventitious carbon dioxide, except when carbonate is the desired product. The reflux temperature applied is typically in the range of 90° C.-110° C., for about one day. LDH of this type is known as aged LDH. A variant (known as hydrothermal treatment) is to heat the LDH, often for a relatively short time, to temperatures in excess of 100° C. in an enclosed vessel capable of withstanding high pressures.

The other technique does not reflux the LDH after precipitation. The precipitate is allowed to stir, in its mother liquor, under an inert gas, for one hour, and then stopped. LDH of this type is known as fresh or raw LDH.

In both cases, the precipitate is then separated from its mother liquor, by centrifugation and washed, preferably with high-purity deionized water. This washing step is usually performed two to three times in order to ensure that any unreacted cations/anions are removed from the precipitate.

The difference between fresh and aged LDH is in the degree of cation ordering and crystallinity. The aged LDH shows stronger, well resolved, LDH lattice vibrational modes and sharper, more intense diffraction peaks. Without wishing to be bound by theory, these two factors can likely be attributed to Ostwald ripening.

Ostwald ripening is a process that is worth mentioning. It is a process that attempts to describe the favorable energetics of large crystals versus small crystals, based on surface area and volume. When LDH crystals are first formed from solution, they have a larger surface area and a smaller volume. During the aging process, the crystals end up having a smaller surface area and a larger volume. The energetics of this difference stem from the fact that molecules or ions on the surface of a crystal are less stable than the ones that exist within a crystal lattice. From a kinetic versus thermodynamic point-of-view, the small crystals are kinetically favored, since they form first; the large crystals are thermodynamically favored because they are formed at the expense of the smaller crystals. With this in mind, the Ostwald process is based on a dissolution-precipitation (re-precipitation) mechanism.

### SUMMARY

The present invention relates to a flame-resistant material or retardant, and more specifically to the preparation and composition of LDHs with specific anions, such as sulfanilic acid, p-toluenesulfonic acid, or 4-chlorobenzenesulfonic acid. In a preferred embodiment of the invention these LDHs with specific ions may also be altered by doping them with nickel to replace a fraction of the divalent metal present.

In a preferred embodiment of the invention, an LDH nitrate may be prepared by dissolving a mixture of trivalent and divalent metal salt of nitrate in deionized water. The resulting metal nitrate solution may then be heated or subjected to gentle reflux, and is precipitated from solution, preferably using 50% w/w NaOH, and washed, to give an LDH nitrate.

The resulting LDH nitrate may then be treated to exchange the nitrate with a desired anion, preferably by adding a solution of a sulfonic acid salt. In a preferred embodiment of the invention, the sulfonic acid salt may be chlorobenzenesulfonate (CBS). The resulting LDH sulfonate suspension is stirred before it is centrifuged and washed. The final product may be recovered through Büchner filtration and/or centrifugation and dried to give an LDH with exchanged anion.

The LDH with exchanged ion may then be combined with nickel chloride solution, then separated and washed to give a nickel-doped LDH with exchanged anion.

The nickel-doped LDHs with exchanged anion composition may be useful as flame retardants, among many other possible uses including as antacids, drug-delivery systems, modified electrodes, polymer stabilizers, adsorbents, electro-photoactive materials, and catalysts or catalyst precursors.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 shows a titration curve of a 2:1 Mg—Al LDH-Cl, starting with a 0.3M MgCl2 and 0.1M AICl3 solution, then titrating with a diluted 50% NaOH solution (6 moles OH⁻ for every 1 mole Al³⁺);

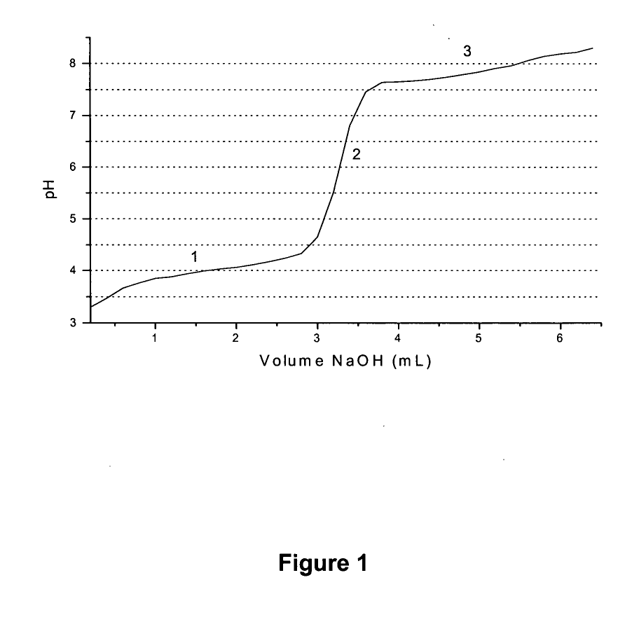

FIG. 2 shows (a) FT-IR of 2:1 Mg—Al LDH-X: A) Parent LDH-NO₃; B) LDH-CBS; C) LDH-CBS with Ni; (b) FT-IR of 2:1 Zn—Al LDH-X: A) Parent LDH-NO₃; B) LDH-PTS; C) LDH-PTS with Ni;

FIG. 3 shows (a) XRD of 2:1 Mg—Al LDH-X: A) Parent LDH-NO₃; B) LDH-CBS; C) LDH-CBS with Ni; (b) XRD of 2:1 Zn—Al LDH-X: A) Parent LDH-NO₃; B) LDH-CBS; C) LDH-CBS with Ni;

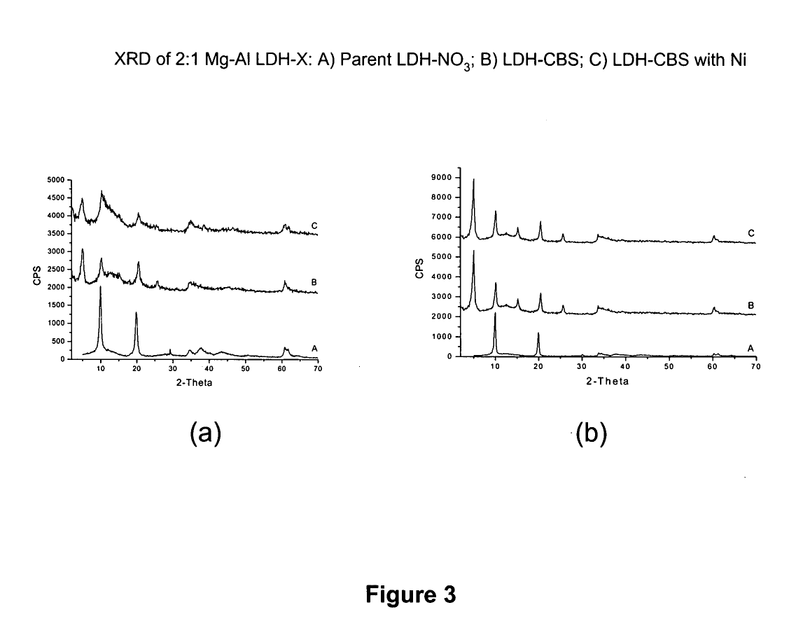

FIG. 4 shows FTIR Spectrum of sodium sulfanilate;

FIG. 5 shows FTIR spectrum of 2:1 Mg Al LDH Sulfanilate;

FIG. 6 shows XRD pattern of 2:1 Mg Al LDH Sulfanilate;

FIG. 7 shows FTIR spectrum of 2:1 Mg Al Sulfanilate with nickel;

FIG. 8 shows XRD pattern of 2:1 Mg Al LDH Sulfanilate with nickel;

FIG. 9 shows (a) TGA comparison of 2:1 Mg Al LDH sulfanilate with and without nickel in nitrogen. (b) DTGA comparison of 2:1 Mg Al LDH Sulfanilate with and without nickel in nitrogen;

FIG. 10 shows (a) TGA comparison of 2:1 Mg Al LDH Sulfanilate with and without nickel in air. (b) DTGA comparison of 2:1 Mg Al LDH sulfanilate with and without nickel in air;

FIG. 11 shows FTIR spectrum of 2:1 Zn Al LDH Sulfanilate;

FIG. 12 shows FTIR spectrum of 2:1 Zn Al Sulfanilate with nickel;

FIG. 13 shows XRD pattern of 2:1 Zn Al LDH Sulfanilate;

FIG. 14 shows XRD pattern of 2:1 Zn Al LDH Sulfanilate with nickel;

FIG. 15 shows (a) TGA comparison of 2:1 Zn Al LDH Sulfanilate with and without nickel in nitrogen. (b) DTGA comparison of 2:1 Zn Al LDH Sulfanilate with and without nickel in nitrogen;

FIG. 16 shows (a) TGA comparison of 2:1 Zn Al LDH Sulfanilate with and without nickel in air. (b) DTGA comparison of 2:1 Zn Al LDH Sulfanilate with and without nickel in air;

FIG. 17 shows FTIR spectrum of Sodium p-Toluenesulfonate;

FIG. 18 shows FTIR spectrum of 2:1 Mg Al p-Toluenesulfonate;

FIG. 19 shows XRD pattern for 2:1 Mg Al LDH p-Toluenesulfonate;

FIG. 20 shows FTIR spectrum of 2:1 Mg Al LDH p-Toluenesulfonate with nickel;

FIG. 21 shows XRD pattern for 2:1 Mg Al LDH p-Toluenesulfonate with nickel;

FIG. 22 shows (a) TGA comparison of 2:1 Mg Al LDH p-Toluenesulfonate with and without nickel in nitrogen. (b) DTGA comparison of 2:1 Mg Al LDH p-Toluenesulfonate with and without nickel in nitrogen;

FIG. 23 shows (a) TGA comparison of 2:1 Mg Al LDH p-Toluenesulfonate with and without nickel in air. (b) DTGA comparison of 2:1 Mg Al LDH p-Toluenesulfonate with and without nickel in air;

FIG. 24 shows FTIR spectrum of 2:1 Zn Al LDH p-Toluenesulfonate;

FIG. 25 shows FTIR spectrum of 2:1 Zn Al LDH p-Toluenesulfonate with nickel;

FIG. 26 shows XRD pattern of 2:1 Zn Al LDH p-Toluenesulfonate;

FIG. 27 shows XRD pattern of 2:1 Zn Al LDH p-Toluenesulfonate with nickel;

FIG. 28 shows (a) TGA comparison of 2:1 Zn Al LDH p-Toluenesulfonate with and without nickel in nitrogen. (b) DTGA comparison of 2:1 Zn Al LDH p-Toluenesulfonate with and without nickel in nitrogen;

FIG. 29 shows (a) TGA comparison of 2:1 Zn Al LDH p-Toluenesulfonate with and without nickel in air. (b) DTGA comparison of 2:1 Zn Al LDH p-Toluenesulfonate with and without nickel in air;

FIG. 30 shows FTIR spectrum of sodium 4-chlorobenzenesulfonate;

FIG. 31 shows FTIR spectrum of 2:1 Mg Al LDH 4-chlorobenzenesulfonate;

FIG. 32 shows XRD pattern of 2:1 Mg Al LDH 4-chlorobenzenesulfonate;

FIG. 33 shows FTIR spectrum of 2:1 Mg Al LDH 4-chlorobenzenesulfonate with nickel;

FIG. 34 shows XRD pattern of 2:1 Mg Al LDH 4-chlororbenzenesulfonate with nickel;

FIG. 35 shows TGA comparison of 2:1 Mg Al LDH 4-chlorobenzenesulfonate with and without nickel in nitrogen. (b) DTGA comparison of 2:1 Mg Al LDH 4-chlorobenzenesulfonate with and without nickel in nitrogen;

FIG. 36 shows (a) TGA comparison of 2:1 Mg Al LDH 4-chlorobenzenesulfonate with and without nickel in air. (b) DTGA comparison of 2:1 Mg Al LDH 4-chlorobenzenesulfonate with and without nickel in air;

FIG. 37 shows FTIR spectrum of 2:1 Zn Al 4-Chlorobenzenesulfonate;

FIG. 38 shows FTIR spectrum of 2:1 Zn Al LDH 4-chlorobenzenesulfonate with nickel;

FIG. 39 shows XRD pattern of 2:1 Zn Al LDH 4-chlorobenzenesulfonate;

FIG. 40 shows XRD pattern of 2:1 Zn Al LDH 4-chlorobenzenesulfonate with nickel;

FIG. 41 shows (a) TGA comparison of 2:1 Zn Al LDH 4-chlorobenzenesulfonate with and without nickel in nitrogen. (b) DTGA comparison of 2:1 Zn Al LDH 4-chlorobenzenesulfonate with and without nickel in nitrogen;

FIG. 42 shows (a) TGA comparison for 2:1 Zn Al LDH 4-chlorobenzenesulfonate with and without nickel in air. (b) DTGA comparison for 2:1 Zn Al LDH 4-chlorobenzenesulfonate with and without nickel in air;

FIG. 43 shows an FTIR spectrum of 2:1 Zn—Al LDH 4-chlorobenzenesulfonate. The trace quantity of residual nitrate is indicated by the asterisk*;

FIG. 44 shows an FTIR spectrum of 2:1 Zn—Al LDH 4-chlorobenzenesulfonate with nickel. Residual nitrate is again indicated by the asterisk*;

FIG. 45 shows an XRD pattern of 2:1 Zn—Al LDH 4-chlorobenzenesulfonate. The basal spacing is indicated by the asterisk*; and

FIG. 46 shows an XRD pattern of 2:1 Zn—Al LDH 4-chlorobenzenesulfonate with nickel. The basal spacing is again indicated by the asterisk*.

### DETAILED DESCRIPTION OF PREFERRED EMBODIMENTS

The present invention relates to flame retardant or flame-resistant material, and, more specifically, to the preparation and composition of LDHs with specific anions, such as 2:1 Zn Al and 2:1 Mg Al LDHs. The anions used for this purpose may be derived from benzene sulfonic acids substituted with amine (for example, in the case of sulfanilic acid), with alkyl or aryl group (for example, in the case of p-toluenesulfonic acid) and with halide (for example, in the case of 4-chlorobenzenesulfonic acid) The resulting LDHs may then be blended with a polymer such as PET, which results in particular thermal stabilities and flame retardant properties. In a preferred embodiment of the invention these LDHs with specific ions may also be altered by doping them with nickel to replace a fraction of the divalent metal present, which results in altered thermal stabilities and flame retardant properties.

In a preferred embodiment of the invention, a parent LDH nitrate may be prepared, such as a 2:1 Mg—Al LDH-NO₃ or a 2:1 Zn—Al LDH-NO₃. This can be accomplished by dissolving a trivalent or divalent metal salt of nitrate, or combination of several such salts, for example Al(NO₃)₃.9H₂O and Mg(NO₃)₂.6H₂O, or Al(NO₃)₃.9H₂O and Zn(NO₃)₂.6H₂O, in water. Other examples of divalent cations for the LDH nitirate include Ni²⁺, Co²⁺, Zn²⁺, Fe²⁺, Mn²⁺, Cu²⁺, Ti²⁺, cd²⁺, Pd²⁺ and Ca²⁺, and other examples of trivalent cations for the LDH nitirate include Al³⁺, Ga³⁺, Fe³⁺, Cr³⁺, Mn³⁺Co³⁺, V³⁺, In³⁺, Y³⁺, La³⁺, Rh³⁺, Ru³⁺, and Sc³⁺. The resulting metal nitrate solution may then be heated, and is precipitated from solution, preferably using 50% w/w NaOH.

The resulting suspension may then be subjected to warming or gentle reflux at approximately 50° C. to 110° C., preferably about 90° C.-110° C., under a steady blanket of nitrogen or other inert gas, preferably for a period of about 24 hours. Alternatively, it may be heated in a sealed pressure-resistant container at a higher temperature, typically up to 140° C. The suspension may then be separated from solution, preferably by centrifugation, and the precipitates washed with deionized water, preferably up to three times, to give an LDH nitrate.

The resulting LDH nitrate may then be treated to exchange the nitrate with a desired anion, for example Cl⁻, CO₃²⁻, SO₄²⁻ and various organic carboxylates, sulfates and sulfonates. The exchange is preferably accomplished by adding a solution of a sulfonic acid salt with stirring such that there are at least the same number of moles of salt (or twice the number in case of sulfanilate) as there are of nitrate in the LDH nitrate. In a preferred embodiment of the invention, the sulfonic acid salt may be CBS. The resulting LDH sulfonate suspension may be stirred under a continuous flow of nitrogen or other inert gas, preferably for about an hour, before it is centrifuged and washed. The final product may be recovered through Büchner filtration, with the aid of methanol, and is then dried in the hot air oven at a temperature of 700 C, to give an LDH with exchanged anion.

A general formula describing the LDH with exchanged anion may be:

[M^{(II)}₁₋ₓM^{(III)}ₓ(OH)₂]^{x+}(A^{m-})_{x/m}.nH₂O

wherein counter-anion A^{m-} represents the exchangeable anion, such as NO₃⁻, Cl⁻, CO₃²⁻, SO₄²⁻ and various organic carboxylates, sulfates and sulfonates. M^{(II)} represents a divalent cation, and could be any ion with a radius that is reasonably similar to Mg²⁺. Examples of possible divalent cations include Ni²⁺, Co²⁺, Zn²⁺, Fe²⁺, Mn²⁺, Cu²⁺, Ti²⁺, Cd²⁺, Pd²⁺, and Ca²⁺. M^{(III)} represents a trivalent cation, and could be any ion with a radius that is reasonably similar to Al³⁺. Examples of possible trivalent ions include Al³⁺, Ga³⁺, Fe³⁺, Cr³⁺, Mn³⁺, Co³⁺, V³⁺, In³⁺, Y³⁺, La³⁺, Rh³⁺, Ru³⁺, and Sc³⁺.

Here x is the fraction of M^{(II)} in M(OH)₂ replaced by M^{(III)}, m is the charge on the anion (which can take any whole number value but is usually in the range from 1 to 4, unless the anion is polymeric), and n is the number of molecules of water per M(OH)₂ unit. The value of n is dependent on material and conditions, and may even be zero, but is typically a positive number around 1.5 or 2.

In yet another preferred embodiment, the LDH with exchanged anion may be incorporated with a dopant metal, such as nickel, to give a metal-doped LDH. In one embodiment, the separated and washed LDH with exchanged anion, preferably about 25 g, is placed in a container, preferably a 5000 mL three-necked roundbottom flask, with water, preferably about 500 mL. A solution of a nickel compound is added to the LDH with exchanged anion. The resulting mixture is stirred, preferably for about one hour, then removed for separation and washing. The final product may be recovered through Büchner filtration, with the aid of methanol, and then dried in an oven, preferably at about 50° C. to 100° C., preferably about 70° C., to give a nickel-doped LDH with exchanged anion.

A general formula following this procedure could be given as

[M^{(II)}_{1-x-y}Ni^{(II)}_{y}M^{(III)}ₓ(OH)₂]^{x+}(A^{m-})_{x/m}*nH₂O

wherein counter-anion A^{m-} represents the exchangeable anion, such as NO₃⁻, Cl⁻, Co₃²⁻, SO₄²⁻ and various organic carboxylates, sulfates and sulfonates. M^{(II)} represents a divalent cation, and could be any ion with a radius that is reasonably similar to Mg²⁺. Examples of possible divalent cations include Ni²⁺, Co²⁺, Zn²⁺, Fe²⁺, Mn²⁺, Cu²⁺, Ti²⁺, Cd²⁺, Pd²⁺, and Ca²⁺. M^{(III)} represents a trivalent cation, and could be any ion with a radius that is reasonably similar to Al³⁺. Examples of possible trivalent ions include Al³⁺, Ga³⁺, Fe³⁺, Cr³⁺, Mn³⁺, Co³⁺, V³⁺, In³⁺, Y³⁺, La³⁺, Rh³⁺, Ru³⁺, and Sc³⁺. Ni^{(II)} represents nickel ion, and y represents the fraction of total cation which is Ni^{(II)}, and y is in the range of 0 to 1-x.

Here x is the fraction of M^{(II)} in M(OH)₂ replaced by M^{(III)}. The variable m is the charge on the anion, which can take any whole number value but is usually in the range from 1 to 4, unless the anion is polymeric. If polymeric anions are to be considered, there is no intrinsic upper limit to m. The variable n is the number of molecules of water per M(OH)₂ unit. The value of n is dependent on material and conditions, and may even be zero, but is typically a positive number around 1.5 or 2.

The nickel-doped LDHs with exchanged anion composition may be useful as flame retardants, among many other possible uses including as antacids, drug-delivery systems, modified electrodes, polymer stabilizers, adsorbents, electro-photoactive materials, and catalysts or catalyst precursors.

The term w/w, as used herein, refers to the weight of the first component divided by the weight of the total compound, and expressed as a percent. For example, 1 g of component A combined with component B to form 100 g of mixture C, would be 1% w/w.

### Example 1

### Parent LDH-NO₃ Preparation

For the preparation of a 25 g batch of 2:1 Mg—Al LDH-NO₃ or 2:1 Zn—Al LDH-NO₃, 33.95 g Al(NO₃)₃.9H₂O (90.5 mmol, Alfa Aesar) and 69.62 g Mg(NO₃)₂.6H₂O (271.5 mmol, Alfa Aesar) were dissolved in 900 mL deionized water (Millipore MilliQ Academic, 18.2 MΩ cm⁻¹), then precipitated by the addition of 28.7 mL NaOH (50% w/w, Alfa Aesar), or 26.17 g Al(NO₃)₃.9H₂O (69.8 mmol, Alfa Aesar) and 62.23 g Zn(NO₃)₂.6H₂O (209.2 mmol, Alfa Aesar) were dissolved in 700 mL deionized water (Millipore MilliQ Academic, 18.2 MΩ cm⁻¹), then precipitated by the addition of 22.1 mL NaOH (50% w/w, Alfa Aesar). These white suspensions were then subjected to gentle reflux (90°-110° C.), under a steady blanket of nitrogen gas, for a period of around twenty-four hours. The suspensions were then removed from reflux, separated from solution, and the white precipitates were washed with deionized water. The precipitates were separated and washed two more times.

Anion Exchange of LDH-NO₃ with CBS

An aqueous solution containing 19.42 g CBS (90.5 mmol, acid-form, Aldrich) was prepared in 500 mL of deionized water, then stirred until completely dispersed. This solution was neutralized with 4.7 mL of 50% NaOH, and then added to a 5000 mL three-necked roundbottomed flask, containing the 2:1 Mg—Al LDH-NO₃ precipitate (stirring in 500 mL of deionized water, under a nitrogen blanket). Another aqueous solution containing 14.96 g CBS (69.7 mmol, acid-form, Aldrich) was prepared in 500 mL of deionized water, and also stirred until completely dissolved. This solution was neutralized with 3.6 mL of 50% NaOH, and then added to a different 5000 mL three-necked roundbottomed flask, containing the 2:1 Zn—Al LDH-NO₃ precipitate (stirring in 500 mL of deionized water, under a nitrogen blanket). These two solutions were allowed to stir for one hour, then removed for separation and washing, as previously described. The final products were recovered through Büchner filtration, with the aid of methanol, and then dried in an oven at 70° C.

### Nickel Loading of LDH-CBS

For the materials incorporated with nickel, different 25 g batches of 2:1 Mg—Al or 2:1 Zn—Al LDH-NO₃ were prepared, then exchanged with deprotonated CBS. After these batches of LDH-CBS were separated and washed, they were placed back in their respective 5000 mL three-necked roundbottomed flasks, along with 500 mL of deionized water. For the 2:1 Mg—Al LDH-CBS sample, 21.52 g of NiCl₂.6H₂O (90.5 mmol, Alfa Aesar) was dissolved in 100 mL of deionized water, then added to the LDH suspension. For the 2:1 Zn—Al LDH-CBS sample, 16.57 g of NiCl₂.6H₂O (69.7 mmol, Alfa Aesar) was dissolved in 100 mL of deionized water, then added to the LDH suspension. Both of these LDH suspensions were allowed to stir for one hour, then removed for separation and washing, as previously described. The final products were also recovered through Büchner filtration, with the aid of methanol, and then dried in an oven at 70° C.

All LDH-CBS materials were characterized by FT-IR, powder XRD, flame AAS and TGA/DTGA.

All FT-IR spectra were obtained using a Perkin-Elmer Spectrum B, using KBr (FT-IR grade, Alfa Aesar) as background. Each sample was scanned from 4000-400 cm⁻¹, for an average of forty scans, at a resolution of 4 cm⁻¹. The IR spectra were prepared by first running a background pellet containing 0.2000 g KBr, then preparing sample pellets containing 1-2% LDH sample (with KBr added to equal 0.2000 g).

All powder XRD patterns were obtained using a Siemens D-500 series diffractometer, with no internal or external standards used. Each pattern was scanned from 5° to 70° (2θ), using CuKα radiation (λ=1.540562 Å). Each pattern and peak list report was prepared using Jade software.

The metals analysis was conducted using a Perkin-Elmer Aanalyst 300, with Perkin-Elmer supplied standards and element lamps. Pyrolysis experiments (TGA/DTGA) were performed using a Perkin-Elmer TGA6. Each sample was pyrolyzed under nitrogen gas (ALPHAGAZ) and air (Hospital Breathing Grade), from 30° C. to 700° C., at a heating rate of 10° C./min.

### Results

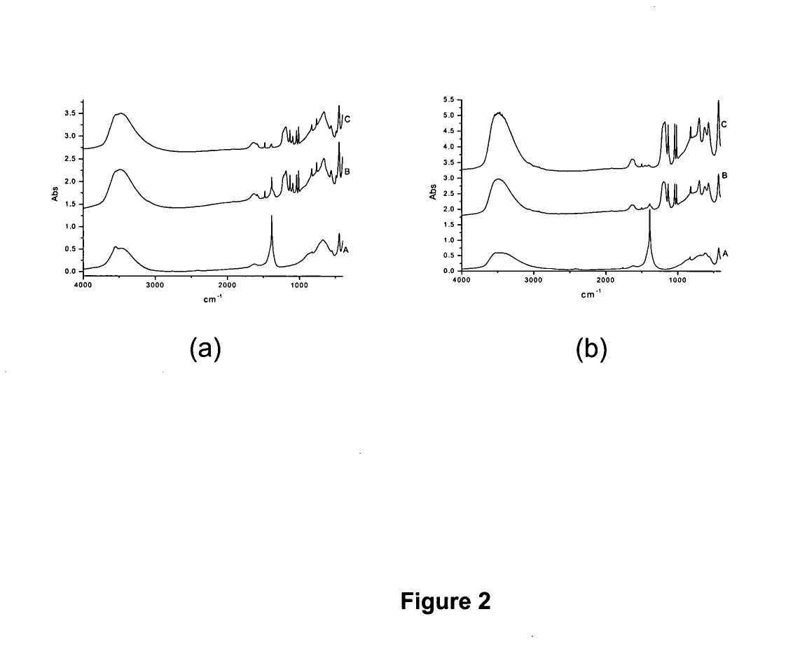

The FT-IR spectra of the 2:1 Mg—Al LDH-CBS and 2:1 Zn—Al LDH-CBS, with and without nickel loading are shown in FIGS. 2a and 2b, along with their respective parent LDH-NO₃. From these two sets of spectra, incorporation of CBS is easily observed (sharp peaks at 1030, 1185 and 1230 cm⁻¹, for the symmetric and asymmetric S═O; sharp peaks at 1010, 1130 and 1480 cm⁻¹ for the aromatic CH groups and the aromatic C═C), but some residual nitrate has remained in all samples (1384 cm⁻¹). There are no major differences in the spectra between the LDH materials and the LDH with nickel materials, for both Mg—Al and Zn—Al, but there are differences between the Mg—Al and Zn—Al samples. The Mg—Al sample shows a strong 447 cm⁻¹ peak and the Zn—Al sample shows a strong 425 cm⁻¹ peak. In both cases, these respective peaks are indicative of a divalent to trivalent metals ratio of 2:1. The importance of these metal-(hydr)oxide lattice peaks shows that for the nickel-loaded samples, the assignments did not change. This means that under these particular conditions the nickel ions did not get incorporated within the LDH lattice, but were instead adsorbed onto the edges and surface of the LDH layers.

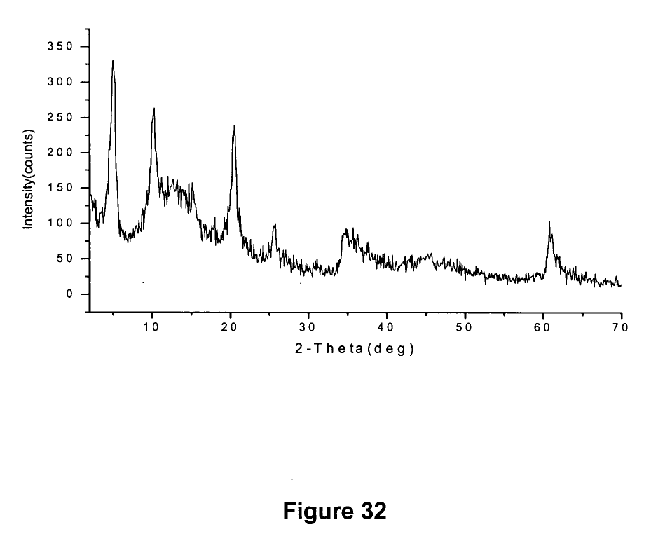

The XRD patterns for the 2:1 Mg—Al LDH-CBS and 2:1 Zn—Al LDH-CBS, with and without nickel loading are shown in FIGS. 32, 34, 39, and 40. There are major differences between the Mg—Al and Zn—Al samples, most notably in the appearance of the reflections. The Zn—Al samples exhibit sharper, more intense reflections than the Mg—Al samples, indicating that the Zn—Al LDH particles have a superior degree of crystallinity. Table 1 below shows that the reflection angles and interlayer spacings are conclusive for CBS intercalated in the LDH interlayers.

TABLE 1

| | (003) | (006) | (009) | (0012) | (110/113) |
|---|---|---|---|---|---|
| 2:1 Mg—Al LDH-CBS | | | | | |
| Reflection Angle (2θ) | 5.00 | 10.27 | 15.36 | 20.66 | 60.81 |
| Interlayer spacing (Å) | 17.35 | 8.6 | 5.76 | 4.29 | 1.52 |
| 2:1 Mg—Al LDH-CBS/Ni: | | | | | |
| Reflection Angle (2θ) | 5.14 | 10.31 | 14.99 | 20.43 | 60.81 |
| Interlayer spacing (Å) | 17.15 | 8.57 | 5.90 | 4.34 | 1.52 |
| 2:1 Zn—Mg Al LDH-CBS | | | | | |
| Reflection Angle (2θ) | 5.67 | 11.41 | 17.22 | 23.08 | 60.21 |
| Interlayer spacing (Å) | 15.56 | 7.74 | 5.14 | 3.85 | 1.53 |
| 2:1 Zn—Al LDH-CBS/Ni | | | | | |
| Reflection Angle (2θ) | 5.08 | 10.37 | 15.38 | 20.71 | 60.45 |
| Interlayer spacing (Å) | 17.36 | 8.52 | 5.75 | 4.28 | 1.53 |

TABLE 2

| LDH Material | Mg:Al ratio | Mg:Ni ratio | Al:Ni ratio |
|---|---|---|---|
| 2:1 Mg—Al LDH-CBS | 2.4:1 | — | — |
| LDH Material | Zn:Al ratio | Zn:Ni ratio | Al:Ni ratio |
| 2:1 Zn—Al LDH-CBS | 2.0:1 | — | — |
| 2:1 Zn—Al LDH-CBS with Ni | 2.0:1 | 273.7:1 | 139.32:1 |

The metals analysis is given in Table 2 above. Each Mg—Al or Zn—Al sample shows close to the theoretical 2:1 divalent to trivalent metal ratios, even in the nickel loaded materials. The 2:1 divalent to trivalent metal ratios give further support, to the IR spectra, that the incorporated nickel did not replace any major amount of magnesium. The nickel analysis shows very little nickel uptake, in both cases. Elemental analysis shows % C, % H, % N and % S values to be close to the theoretical amounts that would have resulted in a complete anion-exchange of nitrate.

Three different sets of comparisons were made: Each Mg—Al or Zn—Al sample under nitrogen versus air, the Mg—Al versus Zn—Al samples, and the LDH-CBS samples versus the nickel loaded LDH-CBS samples. The LDH-CBS materials had a dark-brown to black color to them after pyrolysis (under nitrogen with and without nickel), a light brown to white color under air (without nickel), and a light-green color under air (with nickel). The dark-brown to black color was to be expected and is common due to the formation of a charred material. The light brown to white color indicates that most, if not all of the CBS was thermally decomposed. The light-green color indicates the presence of oxides of nickel.

Both sets of materials have a higher percent weight loss under air than nitrogen. This was to be expected due to the oxidizing effects of oxygen, which promoted the further decomposition of the char.

The Mg—Al and Zn—Al samples show mixed results in percent weight loss, depending on whether nitrogen or air was used. The Zn—Al samples show a higher percent weight loss under air, but the Mg—Al samples show a higher percent weight loss under nitrogen.

The nickel-loaded samples also show mixed results. The Mg—Al samples show no significant weight loss difference between nickel and no nickel (except the 3%, under air), but the Zn—Al samples do not show any difference between nickel and no nickel.

The DTGA traces are also difficult to interpret. There are major differences between the Mg—Al and the Zn—Al samples and between air and nitrogen, but small to no differences in overall weight loss between the samples with or without nickel. However, in air, in a number of cases the nickel-containing samples show a sharper onset of major weight loss, strongly suggesting involvement of the nickel in some catalytic or chain reaction process.

Under nitrogen, the Mg—Al samples show two reduction steps beyond 200° C. There appears to be shifts to lower temperatures for the nickel-loaded sample. Under air, the Mg—Al samples also show two reduction steps beyond 200° C. There also appears to be slight shifts to lower temperatures for the nickel-loaded sample.

Under nitrogen, the Zn—Al samples show two major reduction steps beyond 200° C., with no significant difference between the samples with and without nickel. Under air, the Zn—Al samples show three reduction steps beyond 200° C., for the sample without nickel, but only two reduction steps for the nickel-loaded sample. In general there appears to be a shift to a higher temperature around 300° C., for the sample without nickel, but a shift to lower temperature, around 550° C., for nickel-loaded sample.

TABLE 3

| | |
|---|---|
| Pure PET | 198.08 |
| PET + 5 wt % Mg Al LDH CBS | 234.28 |
| PET + 5 wt % Mg Al LDH CBS-Ni | 223.6 |
| PET + 5 wt % Zn Al LDH CBS | 229.7 |
| PET + 5 wt % Zn Al LDH CBS-Ni | 238.9 |

Microhardness results shown in Table 3 above show that incorporation of all the LDH improve the strength of the PET substantially.

### Example 2

### Introduction

This example deals with the synthesis and analysis of 2:1 Zn Al and 2:1 Mg Al LDHs with three different anions. The anions used for this purpose were benzene sulfonic acids para substituted with amine (in the case of Sulfanilic acid), with methyl group (in the case of p-Toluenesulfonic acid) and with chloride (in the case of 4-chlorobenzenesulfonic acid). These LDHs were also altered from the parent by doping them with nickel to replace a fraction of the divalent metal present, which is either magnesium or zinc and their properties were also studied. This data is presented in tandem with that of the parent for the purpose of comparison and for evaluating the merits of nickel doping.

### Materials Used

All the materials used in the synthesis of the LDHs that will be discussed here were obtained from the manufacturers listed in Table 4 along with their grades. The materials were used as they were bought i.e. without further purification except for the sulfonic acids, which were neutralized with sodium hydroxide to get their sodium salts. The water used was purified by ‘Milli-Q academic’ (18 M′Ω cm⁻¹).

### Synthesis

Preparation of LDHs was done in a two step procedure where the first step was to make the LDH with nitrate as the anion 4 below shows the chemicals used for the synthesis of compounds studied and their sources:

TABLE 4

| Name | Grade | Supplier |
|---|---|---|
| Al(NO₃)₃•9H₂O | 98.0-102% | Alfa Aesar |
| Mg(NO₃)₂•6H₂O | 98% | Alfa Aesar |
| Zn(NO₃)₂•6H₂O | 98% | Sigma-Aldrich |
| NiCl₂•6H₂O | ReagentPlus | Sigma-Aldrich |
| NaOH | 50% w/w aq. Soln. | Alfa Aesar |
| Sulfanilic acid | 99%, A.C.S. reagent | Sigma-Aldrich |
| p-Toluenesulfonic acid | 99% | Acros Organics |
| 4-Chlorobenzenesulfonic | Tech.., 90% | Aldrich |
| acid | | |

In the preparation of LDH nitrate the trivalent and divalent metals salts of nitrate were dissolved together in water to get 0.1M and 0.3M concentrations respectively. This solution of metal salts was then heated to 40° C. and then the calculated amount of 50% w/w Sodium hydroxide was added to the solution. This mixture was refluxed at a temperature of 90-100° C. for 24 hr under a nitrogen gas blanket with continuous stirring. After 24 hr the LDH slurry was allowed to cool for a while and then it was centrifuged to separate LDH from the mother liquor. The LDH thus obtained was not entirely free from the ions in the mother liquor and so it was washed twice with water, again by centrifugation.

In the second step, the LDH nitrate was dispersed in water and a solution of the sulfonic acid salt (anion of choice for the exchange), which has same number of moles of salt (twice the number in case of Sulfanilate) as there are of nitrate in the LDH, was added to it while stirring the slurry thoroughly. The stirring of the slurry was continued under continuous nitrogen flow for about an hour before it was centrifuged and washed twice. The obtained LDH with the desired anion was then dried in the hot air oven at a temperature of 70° C., ground and stored for analysis.

The salts of Sulfonic acids were made in the laboratory by neutralizing the acids with required amount of 50% w/w Sodium hydroxide.

A third step was also carried out in the preparation of nickel doped samples, which was incorporation of a small amount of nickel into the LDH. For this purpose, a solution of nickel chloride which was equimolar to the LDH was added to the LDH of the required anion dispersed in water. This mixture was also stirred for an hour and then centrifuged and washed twice before it was dried and stored.

### Results

### Sulfanilate

The sulfanilate for the exchange was obtained by neutralizing the sulfanilic acid from the manufacturer with required amount of 50% w/w sodium hydroxide.

### 2:1 Mg Al LDH Sulfanilate

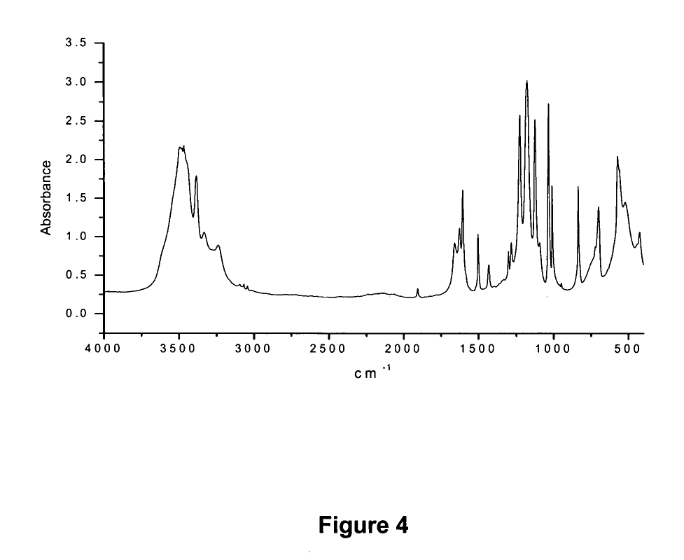

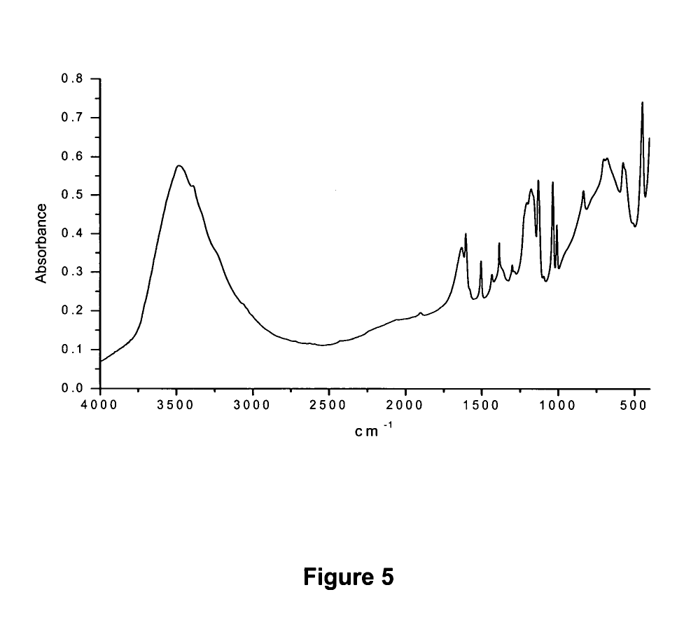

The exchange of the nitrate in the LDH was not complete with 1:1 ratio of sulfanilate to nitrate. The ratio had to be increased to 2:1 to get reasonably complete exchange. The presence of sulfanilate in the LDH was confirmed by matching the infrared spectral peaks of sodium sulfanilate in FIG. 4 to those in the LDH infrared spectra in FIG. 5. The presence of 2:1 Mg Al LDH is confirmed by the peak around 444 cm⁻¹.

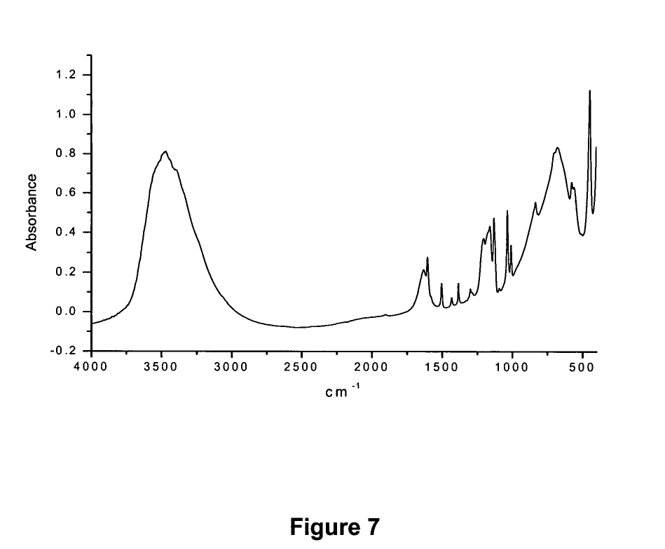

The 2:1 Mg Al LDH sulfanilate was further altered by incorporating some nickel in it. The infrared spectrum of this material is shown in FIG. 7. The infrared spectra of the Mg Al LDH sulfanilate with and without nickel doping look almost the same and both of them have the peaks around 444 cm⁻¹, indicating the 2:1 ratio of magnesium to aluminum. This can be due to the fact that the amount of nickel getting into the LDH was small and the ratio of Mg to Ni was nowhere near 1:1. Atomic absorption spectroscopy data for 2:1 Mg Al LDH Sulfanilate with and without nickel given in Table 5 below also confirms this idea.

TABLE 5

| Name | Mg:Al ratio | Mg:Ni ratio |
|---|---|---|
| 2:1 Mg Al LDH Sulfanilate | 2.5:1 | — |
| 2:1 Mg Al LDH Sulfanilate with | 2.4:1 | 9.7:1 |
| Ni | | |

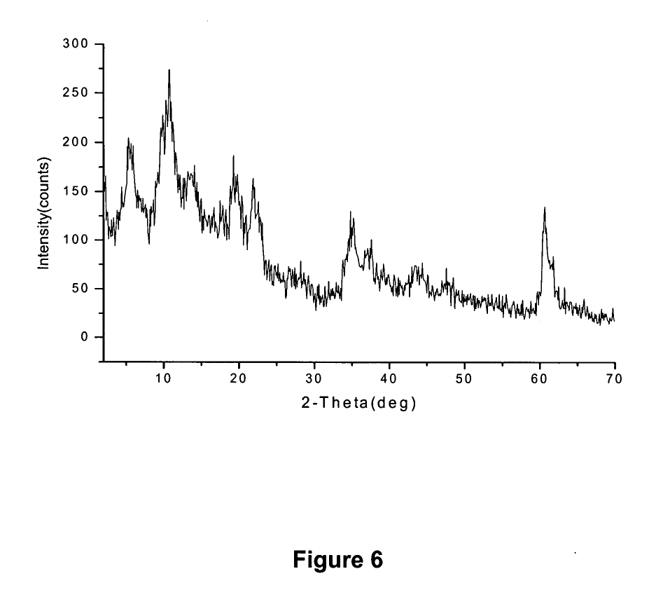

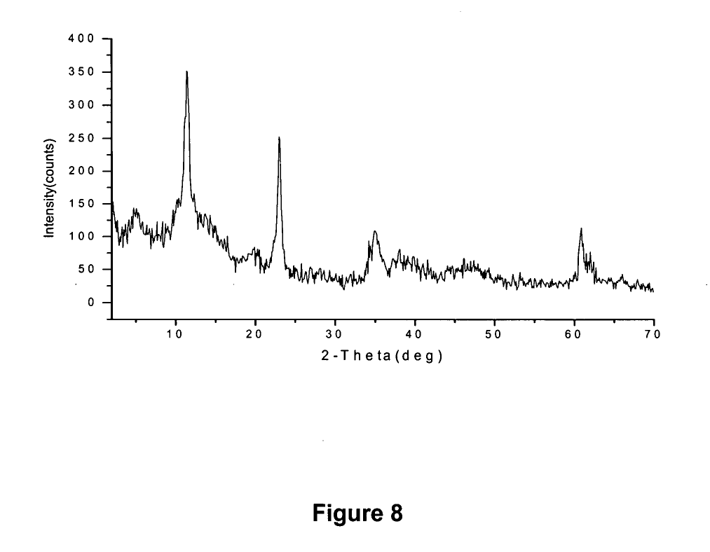

The XRD patterns of the Mg Al LDH sulfanilate and Mg Al Ni sulfanilate are presented in FIGS. 6 and 8 and their similarity augments the assumption of minimal incorporation of nickel and also provides proof of no structural change in the LDH after nickel doping.

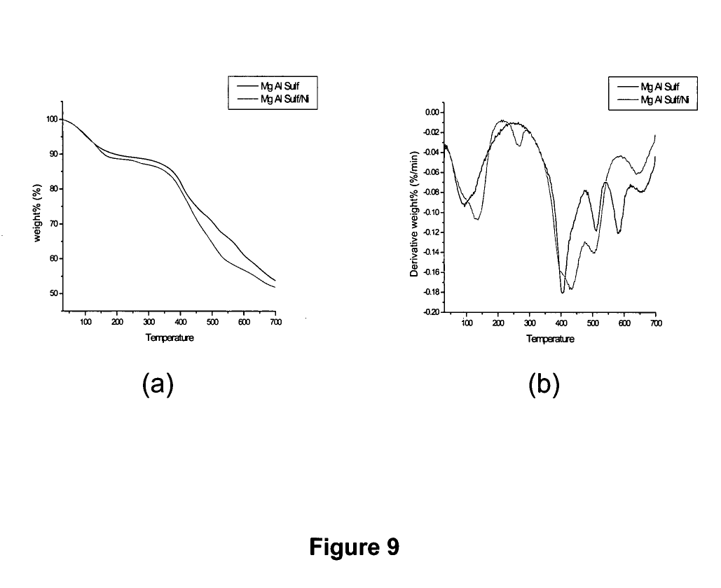

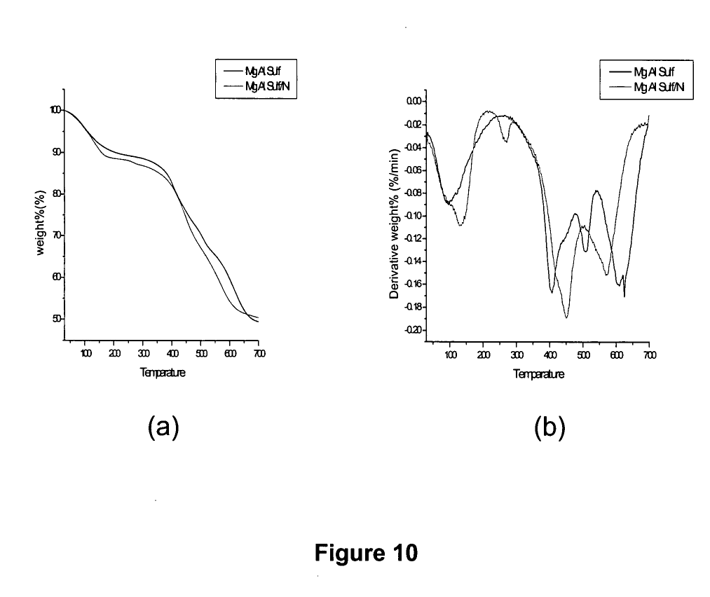

The comparisons of TGA and DTGA carried out in both air and nitrogen, presented in FIGS. 9 and 10 respectively show some significant change in the thermal behavior of the materials with and without nickel doping. The 2:1 Mg Al LDH Sulfanilate containing nickel seems to have accelerated thermal degradation compared to the material that does not have nickel. Table 6 below shows the XRD data of 2:1 Mg Al LDH Sulfanilate with and without nickel

TABLE 6

| Name | 2 theta value | d₀₀₃ value |
|---|---|---|
| 2:1 Mg Al LDH Sulfaniliate | 5.410 | 16.3208 |
| 2:1 Mg Al LDH Sulfanilate | 4.911 | 17.9790 |
| with Ni | | |

2:1 Zn Al LDH sulfanilate

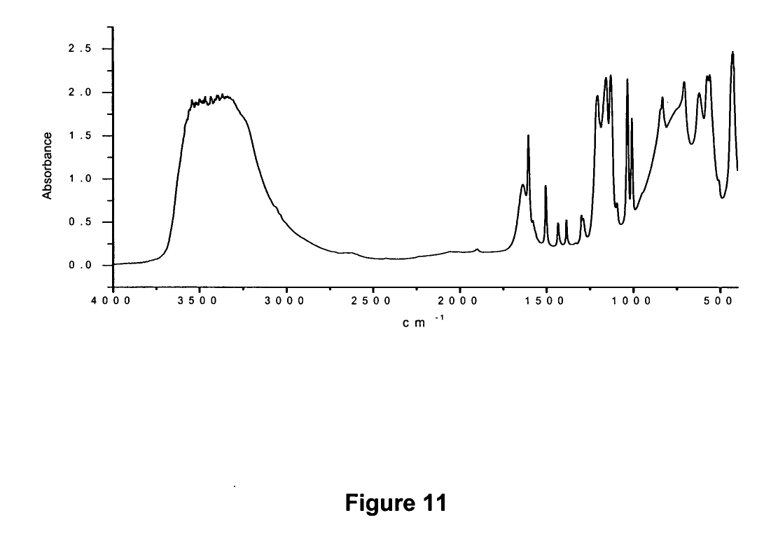

In the case of 2:1 Zn Al LDH nitrate also a 2:1 ratio of sulfanilate to nitrate was needed to get a good exchange. The peak around 425 cm⁻¹ in its infrared spectrum in FIG. 11 confirms the presence of 2:1 Zn Al LDH. The reduction in the 1384 cm⁻¹ peak after the exchange gives proof of replacement of nitrate by sulfanilate.

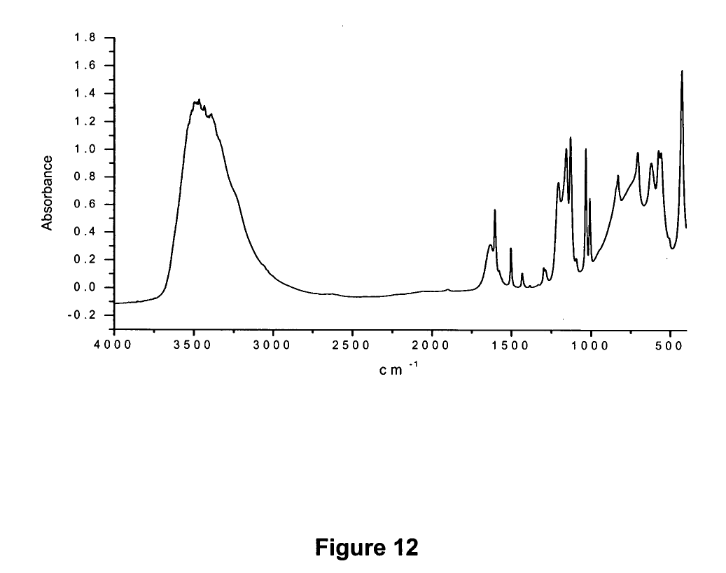

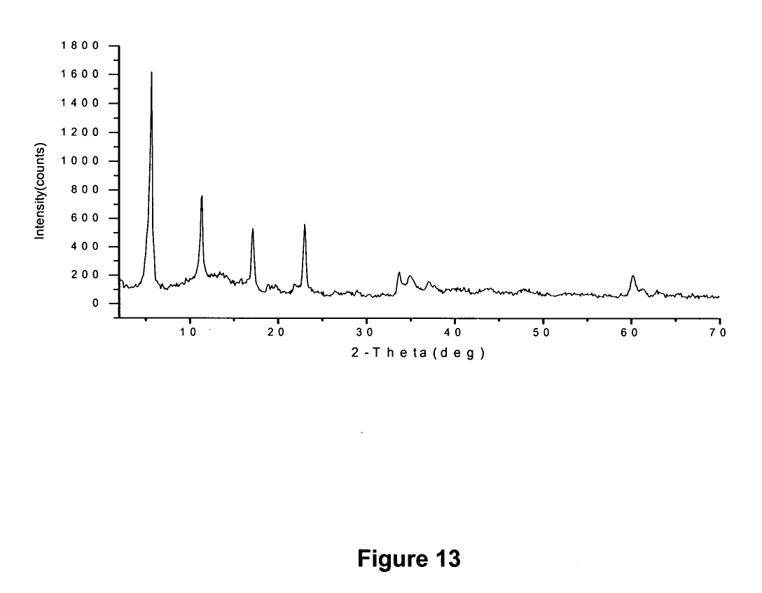

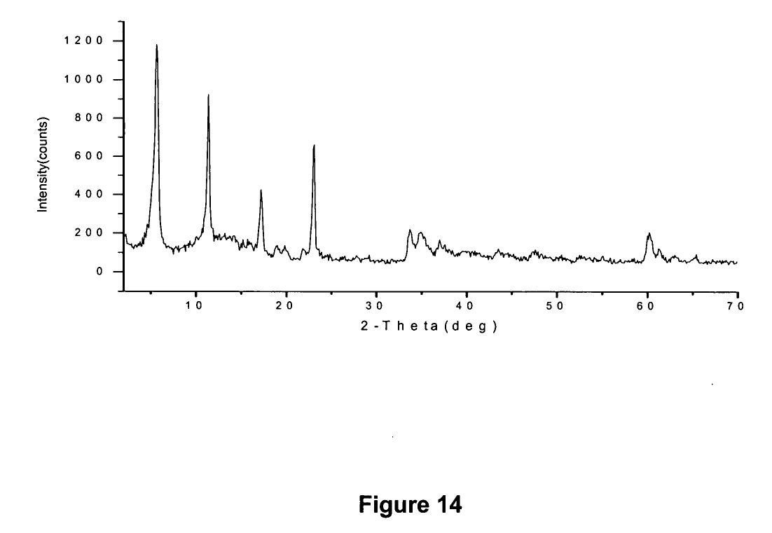

The 2:1 Zn Al LDH Sulfanilate was also doped with nickel and the analytical data of both the parent and the nickel doped LDH were compared. The infrared spectra in FIGS. 11 and 12 show no significant differences. The XRD patterns in the FIGS. 13 and 14 of the materials are also not different in their d₀₀₃ values. This, when coupled with the fact that the atomic absorption data shown in the Table 8 indicates the presence of nickel, suggests that the nickel present is adsorbed on to the surface or edge of the LDH layer and is neither in the gallery space nor incorporated into the structure of the LDH sheets. Table 7 below shows the XRD data for 2:1 Zn Al LDH Sulfanilate with and without nickel. Table 8 below shows the atomic absorption spectroscopic results for 2:1 Zn Al LDH Sulfanilate with and without nickel.

TABLE 7

| Name | 2 theta value | d₀₀₃ value |
|---|---|---|
| 2:1 Zn Al LDH Sulfaniliate | 5.656 | 15.6127 |
| 2:1 Zn Al LDH Sulfanilate | 5.675 | 15.5605 |
| with Ni | | |

TABLE 8

| Name | Zn:Al ratio | Zn:Ni ratio |
|---|---|---|
| 2:1 Zn Al LDH Sulfanilate | 1.9:1 | — |
| 2:1 Zn Al LDH Sulfanilate | 2.0:1 | 23.6:1 |
| with Ni | | |

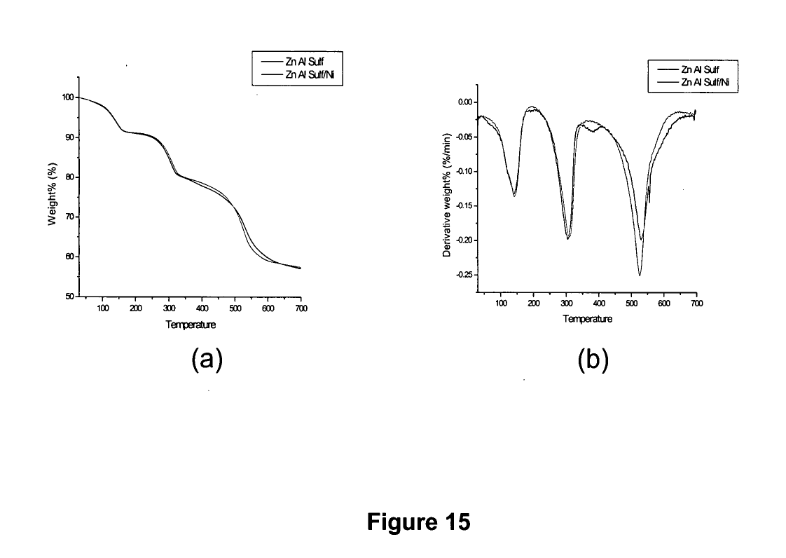

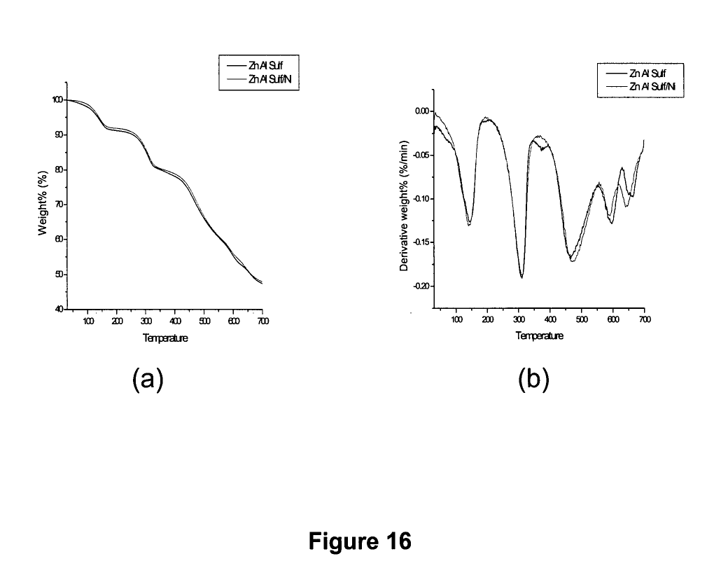

The comparisons TGA and DTGA of these materials collected in atmospheres of nitrogen and air are given in FIGS. 15 and 16 respectively and they show some differences. This data shows that the nickel doped material undergoes faster thermal degradation compared to the parent material.

p-TolueneSulfonate

p-Toluenesulfonate was obtained by neutralizing p-toluenesulfonic acid from the manufacturer with 50% w/w sodium hydroxide.

2:1 Mg Al LDH p-Toluenesulfonate

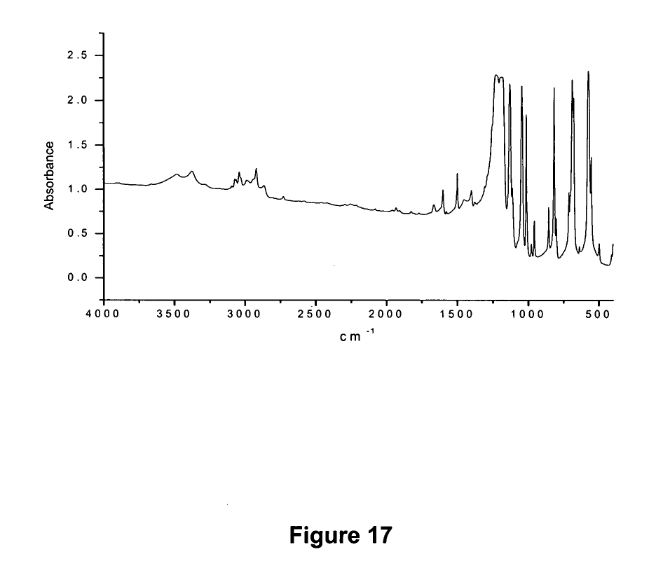

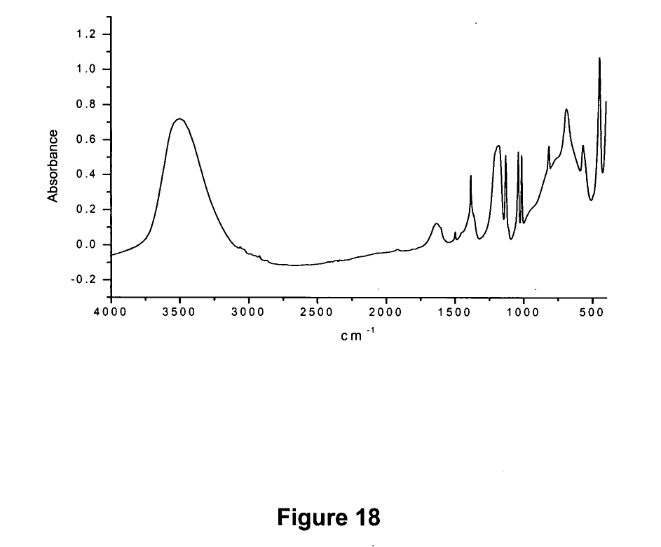

The 2:1 Mg Al LDH p-Toluenesulfonate was prepared by exchanging the 2:1 Mg Al LDH nitrate with one mole of p-Toluenesulfonate for each mole of Aluminum in the LDH nitrate. The infrared spectra of pure p-Toluenesulfonic acid and 2:1 Mg Al LDH p-Toluenesulfonate are shown in FIGS. 17 and 18. The infrared of 2:1 Mg Al LDH p-Toluenesulfonate shows the peak around 444 cm⁻¹ and a reduction in the 1384 cm-1 peak indicating the presence of 2:1 magnesium and aluminum LDH and exchange of nitrate for p-Toluenesulfonate respectively.

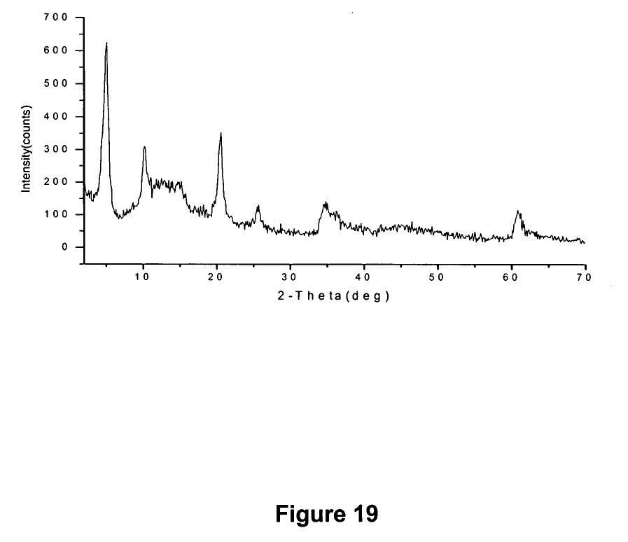

The XRD pattern of 2:1 Mg Al LDH p-Toluenesulfonate in the FIG. 19 demonstrates the incorporation of p-Toluenesulfonate into the interlayer space. The d-spacings for the same are given in Table 9. Table 9 shows the XRD data for 2:1 Mg Al LDH p-Toluenesulfonate with and without nickel.

TABLE 9

| | 2 theta | |
|---|---|---|
| Name | value | d₀₀₃ value |
| 2:1 Mg Al LDH p-Toluenesulfonate | 4.997 | 17.6681 |
| 2:1 Mg Al LDH p-Toluenesulfonate | 4.996 | 17.6731 |
| with Ni | | |

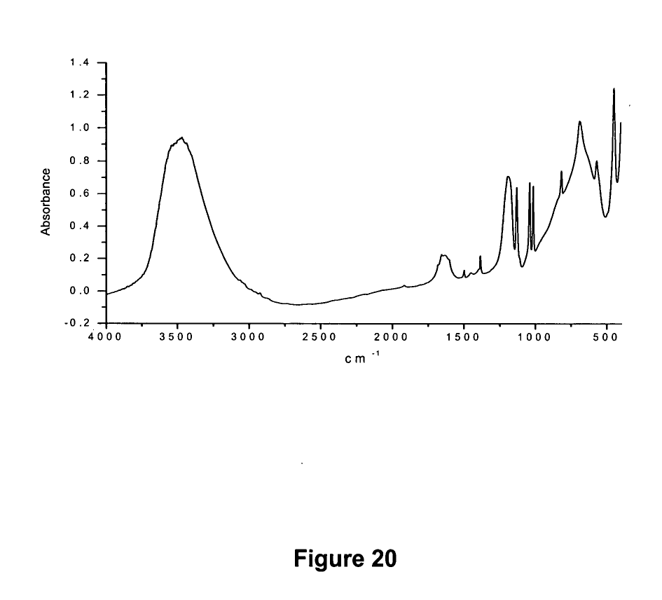

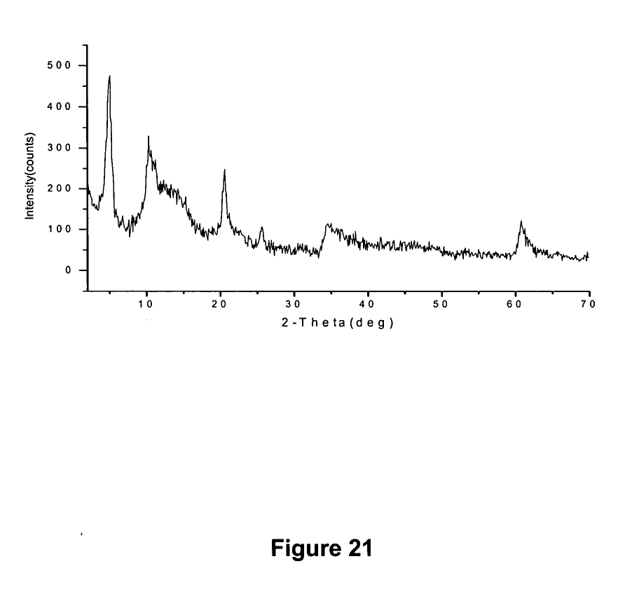

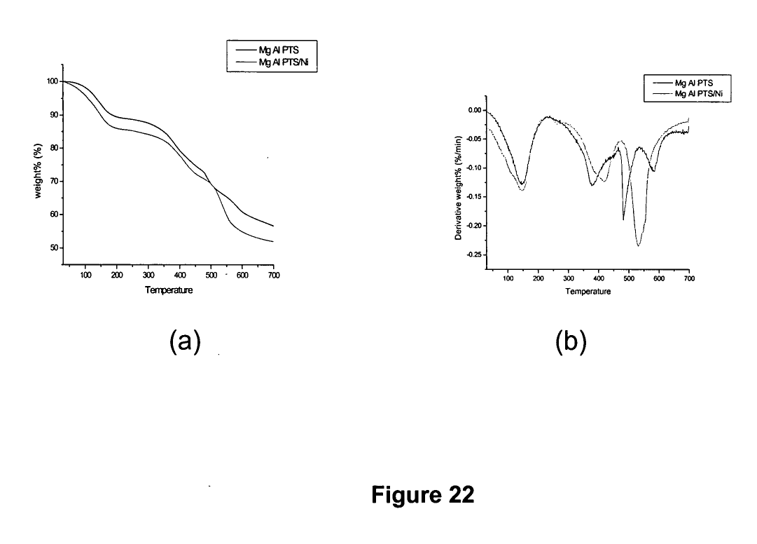

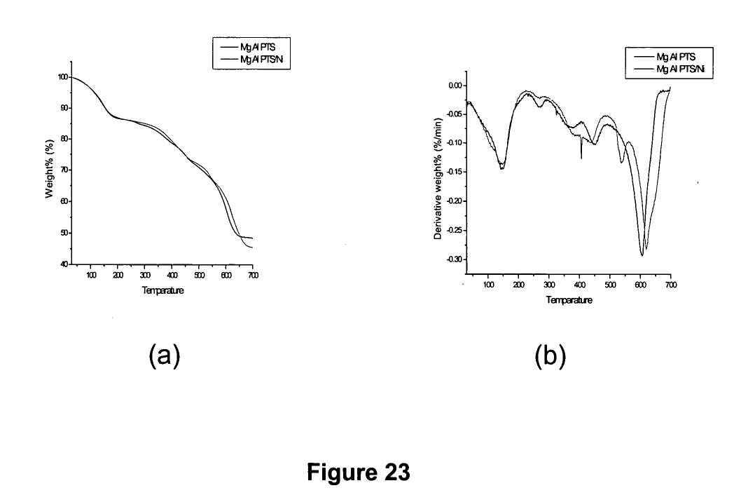

The material is also doped with nickel and was observed for any differences this incorporation would bring. The infrared and XRD patterns for the nickel doped material given in FIGS. 20 and 21 show no major differences from those of the parent material. The presence of nickel however is proved by the atomic absorption results given in Table 10 below. Table 10 shows the atomic absorption spectroscopy results for 2:1 Mg Al LDH p-Toluenesulfonate with and without nickel. The TGA and DTGA comparisons of the parent material and the nickel doped material in FIGS. 22 and 23 also provide proof of difference between the materials. The thermal degradation of material with nickel is slower than that of the parent material.

TABLE 10

| | Mg:Al | Mg:Ni |
|---|---|---|
| Name | ratio | ratio |
| 2:1 Mg Al LDH p-toluenesulfonate | 2.1:1 | — |
| 2:1 Mg Al LDH p-Toluenesulfonate | 2.5:1 | 6.6:1 |
| with Ni | | |

2:1 Zn Al LDH p-Toluenesulfonate

In this case also one mole of p-Toluenesulfonate per each mole of aluminum in the LDH was enough to get a good exchange with the nitrate in the precursor.

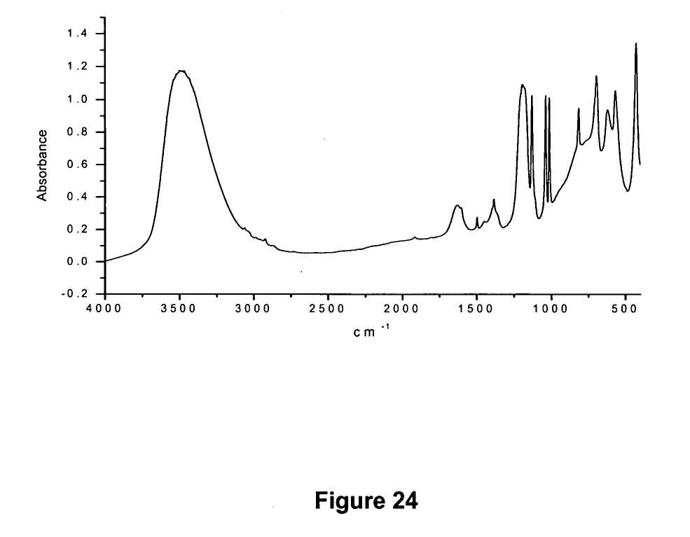

The infrared spectrum of the 2:1 Zn Al LDH p-Toluenesulfonate in FIG. 24 shows evidence of 2:1 Zn Al LDH and the exchange of nitrate with p-Toluenesulfonate i.e. it contains the peak at 425 cm⁻¹ and also shows a reduction in 1384 cm⁻¹ peak.

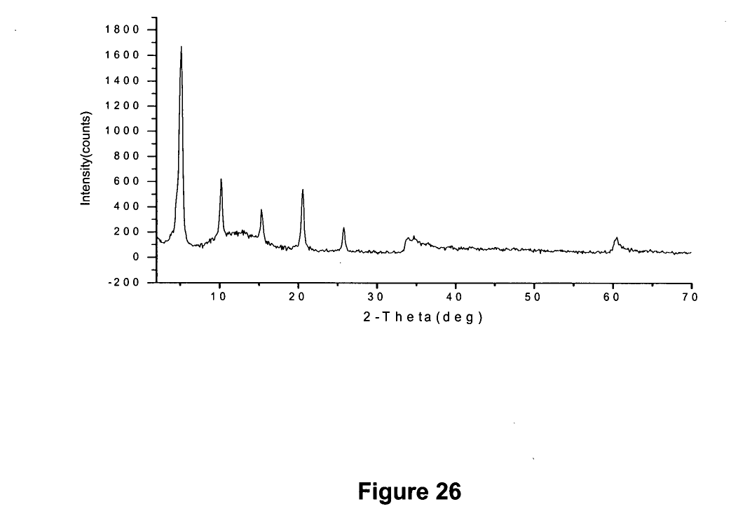

The XRD of the material in the FIG. 26 with a d₀₀₃ of 17.6768 illustrates presence of p-Toluene sulfonate in the interlayer space. The d-spacings are given in Table 12 below.

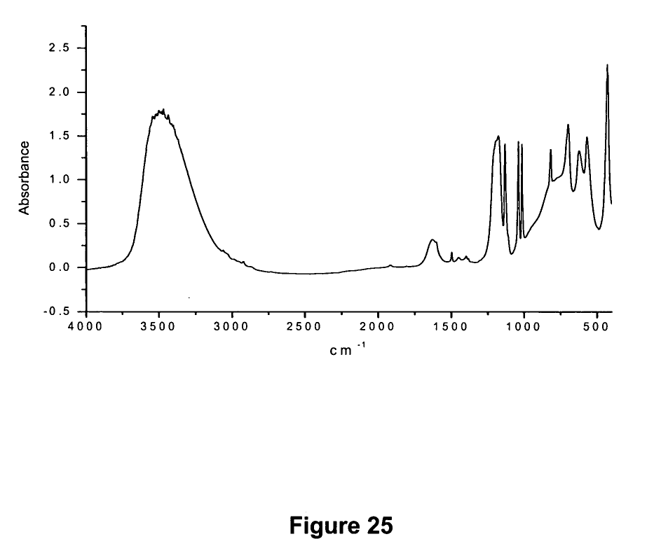

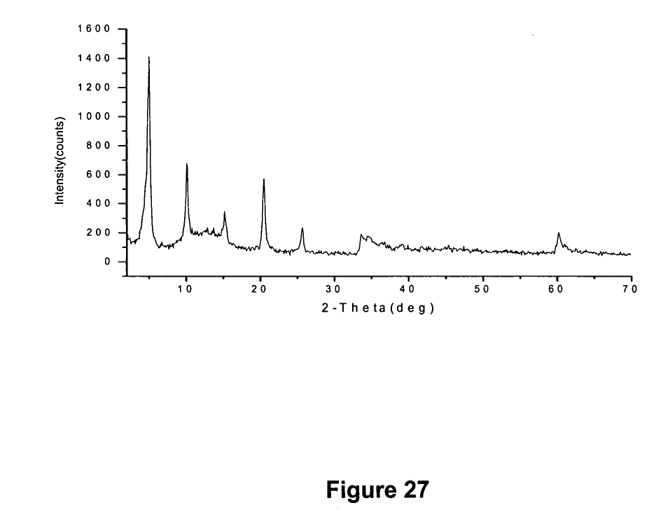

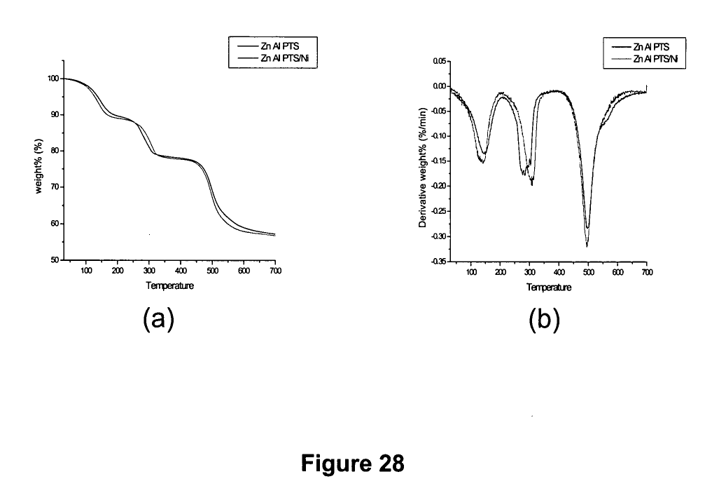

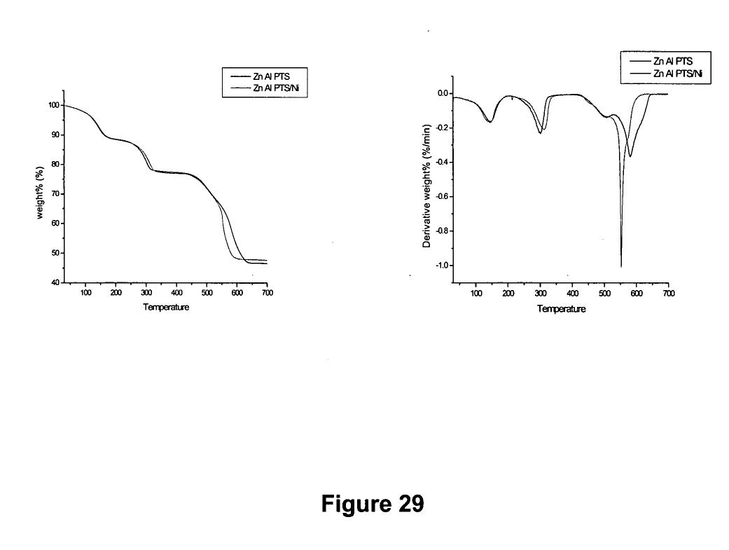

This parent material also when doped with nickel shows no structural changes and this can be demonstrated by the similarity of its infrared and XRD patterns in FIGS. 25 and 27 with those of the parent material. However, again the atomic absorption results of the material when compared to that of the parent as in Table 11 below provide evidence of the nickel in the sample. The TGA and DTGA comparisons of the parent and the nickel doped material in the FIGS. 28 and 29 also differ in that the thermal degradation of nickel doped material is faster than that of the parent compound and shows a sharper onset, especially in air, clearly indicating that the presence of the nickel is modifying the course of the degradation. Table 11 below shows the atomic absorption spectroscopy results for 2:1 Zn Al LDH p-Toluenesulfonate with and without nickel. Table 12 below shows the XRD data for 2:1 Zn Al LDH p-Toluenesulfonate with and without nickel.

TABLE 11

| | Zn:Al | Zn:Ni |
|---|---|---|
| Name | ratio | ratio |
| 2:1 Zn Al LDH p-Toluenesulfonate | 2.1:1 | — |
| 2:1 Zn Al LDH p-Toluenesulfonate | 2.0:1 | 32.5:1 |
| with Ni | | |

TABLE 12

| | 2 theta | |
|---|---|---|
| Name | value | d₀₀₃ value |
| 2:1 Zn Al LDH p-Toluenesulfonate | 5.105 | 17.2976 |
| 2:1 Zn Al LDH p-Toluenesulfonate | 4.995 | 17.6768 |
| with Ni | | |

### 3 4-Chlorobenzenesulfonate

The 4-chlorobenzenesulfonate is prepared by neutralizing 4-chlorobenzenesulfonic acid obtained from the manufacturer with 50% w/w sodium hydroxide.

2:1 Mg Al LDH 4-chlorobenzenesulfonate

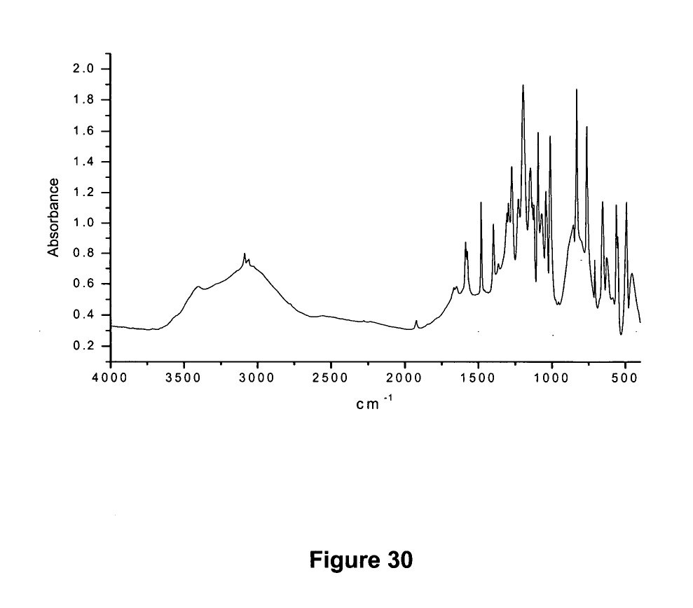

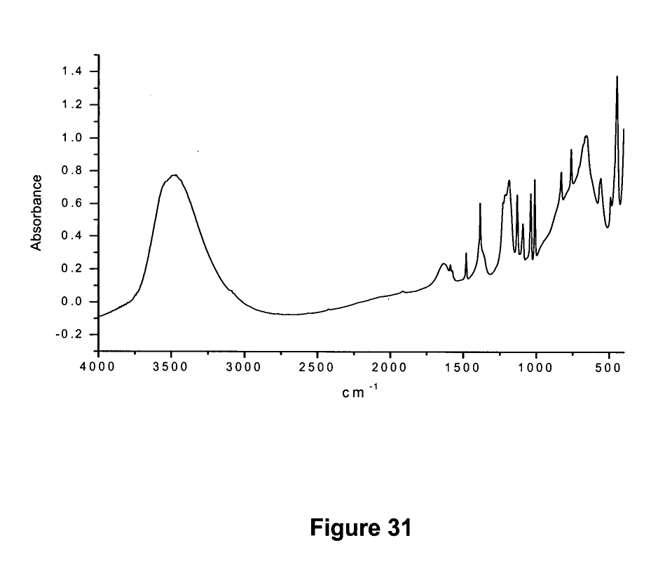

One mole of 4-chlorobenzenesulfonic acid per each mole of aluminum in the LDH was sufficient to get a good exchange with the nitrate in the precursor as in the case of p-Toluene sulfonate. The infrared spectrum of sodium 4-chlorobenzenesulfonate is given in the FIG. 30. The infrared spectrum of 2:1 Mg Al LDH 4-chlorobenzenesulfonate in the FIG. 31 has the evidence of presence of 2:1 Mg Al LDH in that it has the 444 cm⁻¹ and also the reduction in the peak at 1384 cm⁻¹ demonstrates the exchange of nitrate in the precursor with 4-chlorobenzenesulfonate.

The XRD pattern of the material in the FIG. 32 also shows the incorporation of 4-cholrobenzenesulfonate into the interlayer space. The d-spacings are given in Table 13 below. Table 13 shows the XRD data for 2:1 Mg Al LDH 4-chlorobenzenesulfonate with and without nickel.

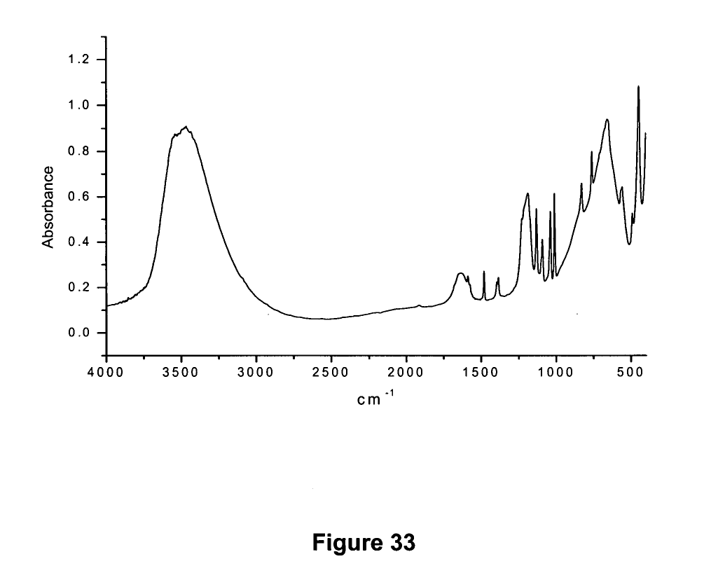

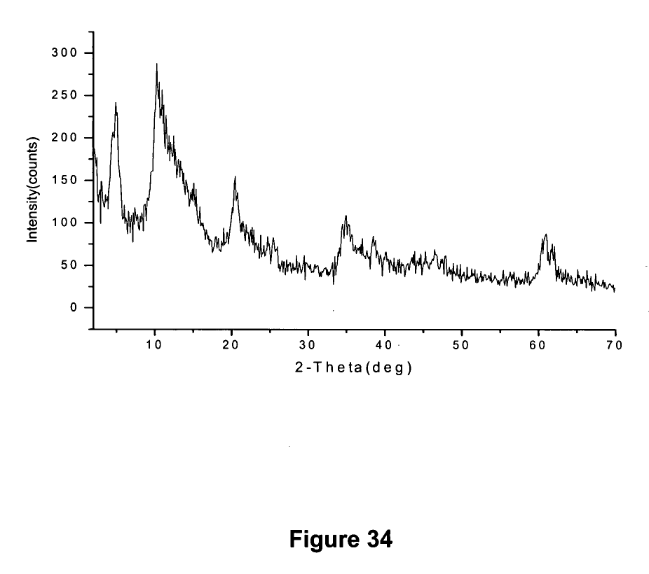

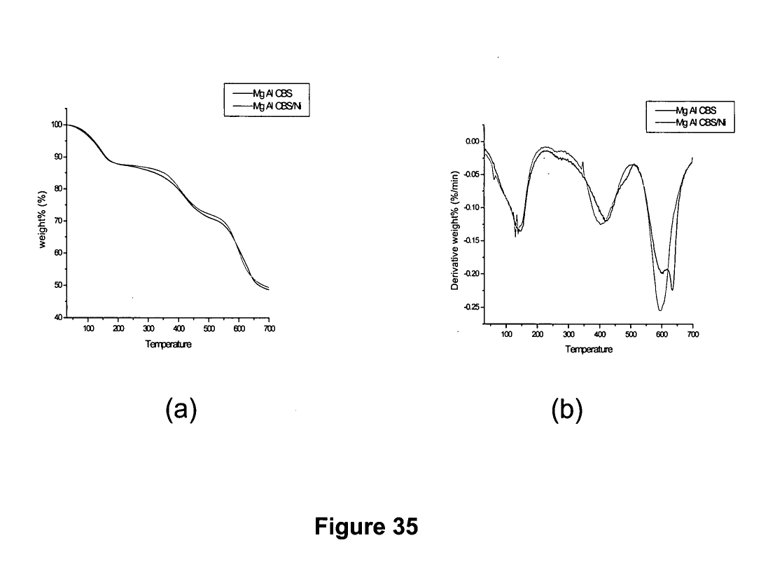

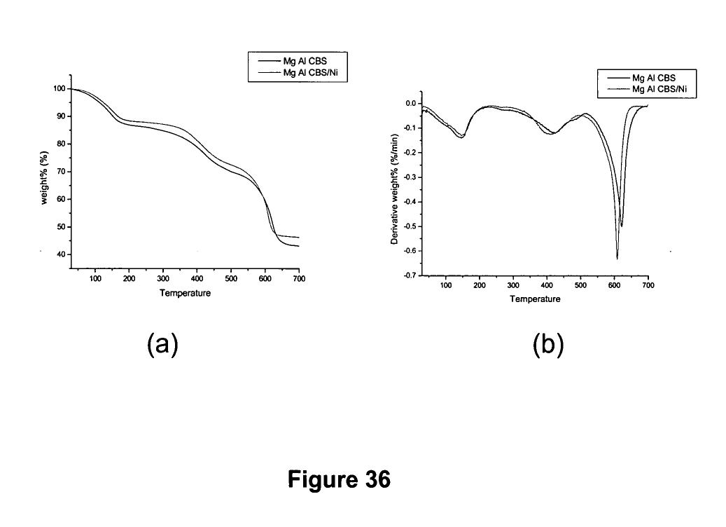

This material also when doped with nickel, as the other materials discussed above does not show any structural changes. This can be illustrated by comparing the infrared spectrum and XRD pattern of this material in FIGS. 33 and 34 with its parent material. The atomic absorption data in Table 14 again gives proof of the presence of nickel in the material. The TGA and DTGA comparisons in FIGS. 35 and 36 of both the materials show that the thermal degradation of nickel doped material is faster than that of the parent material, especially in air, again indicating a significant influence of the presence of nickel on the degradative pathway. Table 14 below shows the atomic absorption spectroscopy data for 2:1 Mg Al LDH 4-chlorobenzenesulfonate with and without nickel

TABLE 13

| | 2 theta | d₀₀₃ |
|---|---|---|
| Name | value | value |
| 2:1 Mg Al LDH 4-cholrobenzenesulfonate | 5.088 | 17.3534 |
| 2:1 Mg Al LDH 4-chlorobenzenesulfonate | 5.147 | 17.1558 |
| with Ni | | |

TABLE 14

| | Mg:Al | Mg:Ni |
|---|---|---|
| Name | ratio | ratio |
| 2:1 Mg Al LDH 4-chlorobenzenesulfonate | 2.4:1 | — |
| 2:1 Mg Al LDH 4-chlorobenzenesulfonate | 2.2:1 | 6:1 |
| with Ni | | |

2:1 Zn Al LDH 4-chlorobenzenesulfonate

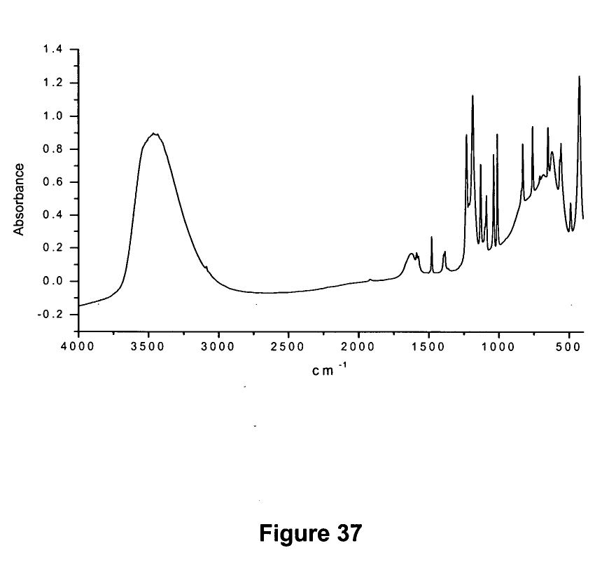

This material is prepared by exchanging 2:1 Mg Al LDH nitrate with one mole of 4-chlorobenzenesulfonate per each mole of aluminum in the material. The infrared spectrum in the FIG. 37 of the material again gives the proof of incorporation of the anion in the LDH and also the peak at 425 cm⁻¹ is an indication for the presence of 2:1 Zn Al LDH.

TABLE 15

| | Zn:Al | Zn:Ni |
|---|---|---|
| Name | ratio | ratio |
| 2:1 Zn Al LDH 4-chlorobenzenesulfonate | 2.0:1 | — |
| 2:1 Zn Al LDH 4-chlorobenzenesulfonate | 2.0:1 | 273.7:1 |
| with Ni | | |

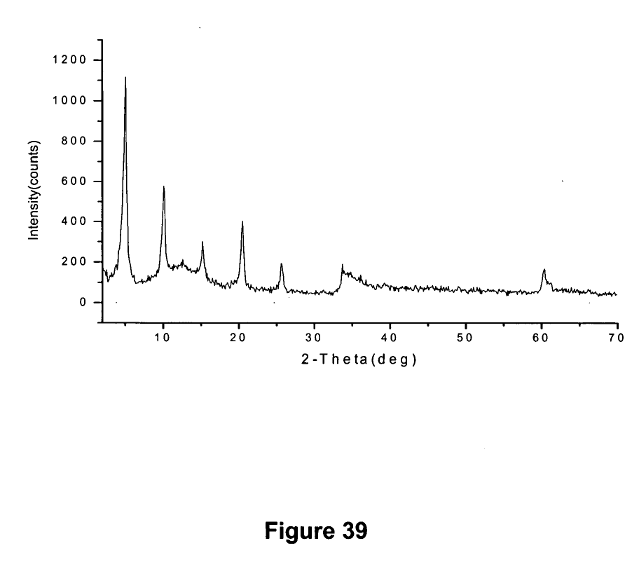

The XRD pattern in the FIG. 39 with a d₀₀₃ of 17.6484 is a proof of the presence of 4-chlorobenzenesulfonate in the interlayer space. The d-spacings are given in Table 16

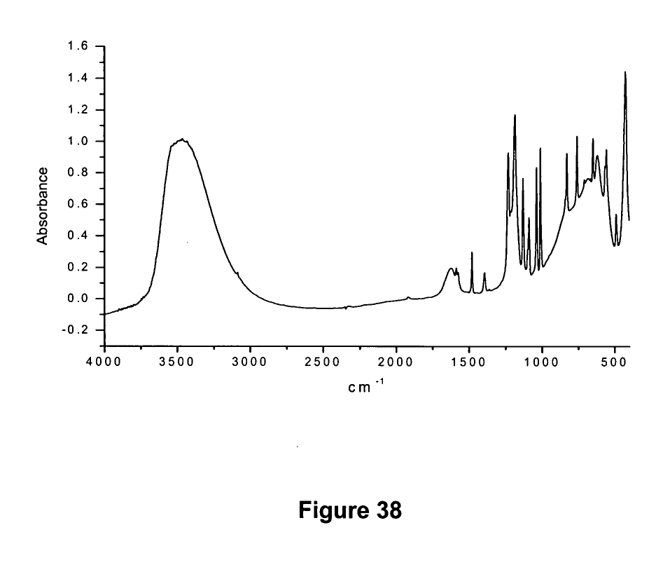

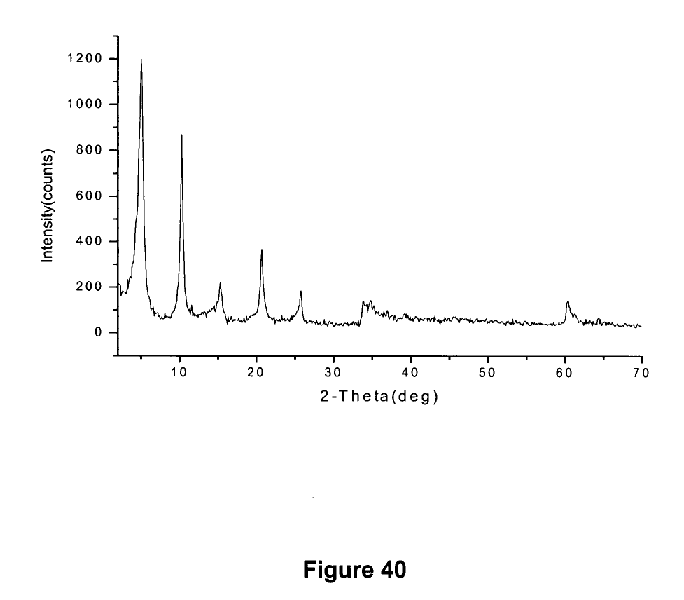

The parent material when doped with nickel in this case also does not show any structural changes. The infrared spectrum and XRD pattern of the nickel doped material in FIGS. 38 and 40 when compared with those of the parent material prove this. The atomic absorption data in Table 15 above shows presence of nickel in the material even though no change is to be seen in the structure. Table 15 above shows the atomic absorption data for 2:1 Mg Al LDH 4-chlorobenzenesulfonate with and without nickel. Table 16 below shows the XRD for 2:1 Zn Al LDH 4-chlorobenzenesulfonate with and without nickel.

TABLE 16

| | 2 theta | d₀₀₃ |
|---|---|---|
| Name | value | value |
| 2:1 Zn Al LDH 4-chlorobenzenesulfonate | 5.003 | 17.6484 |
| 2:1 Zn Al LDH 4-chlorobenzenesulfonate | 5.086 | 17.3601 |
| with Ni | | |

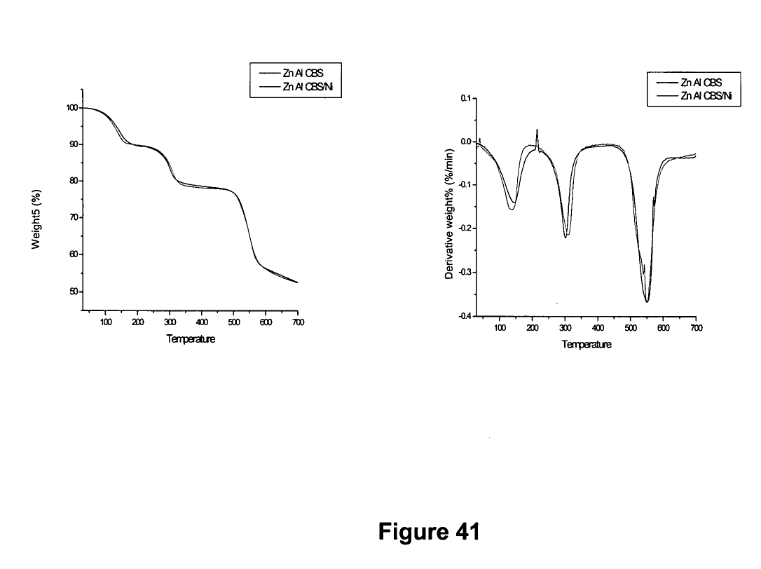

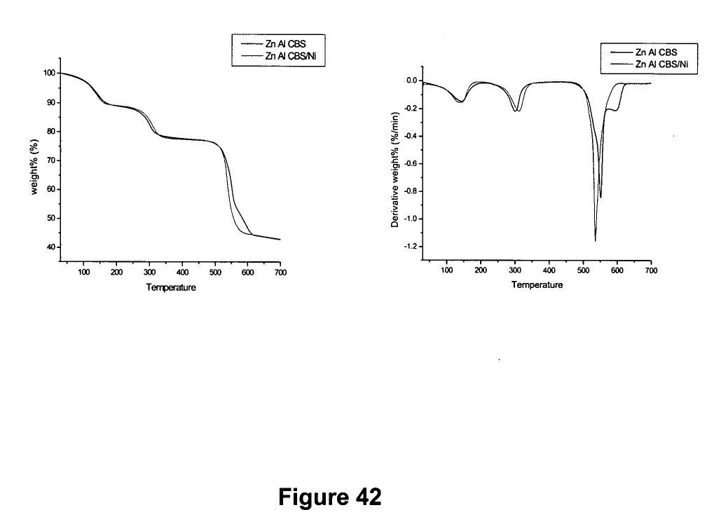

The TGA and DTGA comparisons of the parent and nickel doped materials in the FIGS. 41 and 42 give a further example of accelerated thermal decomposition when the material contains nickel.

### Conclusions

The results indicate that the nitrate route of preparation of LDHs with sulfanilate, p-Toluenesulfonate and 4-chlorobenzenesulfonate is a viable one as it gives good exchange and can also be stepped up the scale to make considerably large batches. 50 gm samples of these materials were made in the procedure discussed above and the results were reproducible. Also, the same interlayer anions give better XRD patterns with zinc as the divalent metal when compared to magnesium, suggesting better structural properties. The ratio of divalent to trivalent metal in zinc LDHs are closer to 2 compared to those in magnesium LDHs which also is an indication of their regular and predictable structure. Zn Al LDHs also showed significantly less amounts of nickel doping compared to Mg Al LDHs which also makes zinc a better choice. The drying of the materials after exchanging with the sulfonate anions did not require a vacuum to avoid carbonate from the air. This is an indication of their resistance to the carbonate contamination, which is desirable as well as profitable in the LDH chemistry. In addition, sulfanilate was needed in excess (twice the number of moles of LDH) to get a decent exchange whereas p-Toluenesulfonate and 4-chlorobenzenesulfonate did not. So, for the purpose of making large batches of materials the latter are the better choice. The incorporation and not exchange of nickel for a fraction of the divalent metal is an interesting result as this restricts the presence of nickel to small amounts, a useful characteristic of metals used as catalysts like nickel itself. Finally, the thermal degradation of nickel doped samples in the majority of cases (the 2:1 Mg Al LDH p-Toluenesulfonate with nickel in air is an exception) is faster than their respective precursors. This further emphasizes nickel's catalytic role.

### Example 3

### Preparation of Materials

Mg—Al and Zn—Al LDH incorporating p-toluenesulfonate, chlorobenzenesulfonate, or p-sulfanilate were prepared, and samples of each of the so prepared materials was loaded with nickel, according to the following procedure:

Preparation of LDHs was done in a two step procedure where the first step was to make the LDH with nitrate as the anion and the second to exchange this nitrate with the desired sulfonate anion. Table 17 below shows the chemicals used for the synthesis of compounds studied and their sources

TABLE 17

| Name | Grade | Supplier |
|---|---|---|
| Al(NO₃)₃•9H₂O | 98.-102% | Alfa Aesar |
| Mg(NO₃)₂•6H₂O | 98% | Alfa Aesar |
| Zn(NO₃)₂•6H₂O | 98% | Sigma-Aldrich |
| NiCl₂•6H₂O | ReagentPlus | Sigma-Aldrich |
| NaOH | 50% w/w aq. Soln. | Alfa Aesar |
| Sulfanilic acid | 99%, A.C.S. reagent | Sigma-Aldrich |
| p-toluenesulfonic acid | 99% | Acros Organics |
| 4-chlorobenzenesulfonic acid | Tech, 90% | Aldrich |

In the preparation of LDH nitrate the trivalent and divalent metals salts of nitrate calculated to give 25 gm of LDH were dissolved together in water to get 0.1M and 0.3M concentrations respectively. The use of excess divalent metal ensures that sodium hydroxide will be the limiting reagent, and avoids excessively high pH. This solution of metal salts was heated to 40° C. and then 50% w/w sodium hydroxide was added to the solution for neutralization. The ratio of hydroxide added to the Al in the LDH is 6:1 as there are six moles of hydroxide per each 2:1 LDH. This mixture was refluxed at a temperature of 90-100° C. for 24 hr under a nitrogen gas blanket with continuous stirring. After 24 hr the LDH slurry is allowed to cool for a while and then it is centrifuged to separate LDH from the mother liquor. LDH thus obtained was not entirely free from the ions in the mother liquor and so it was washed twice with water, again by centrifugation.

In the second step, the LDH nitrate was dispersed in water and a solution of the sulfonic acid salt (anion of choice for the exchange), which has same number of moles of salt (twice the number in case of sulfanilate) as there are of nitrate in the LDH, was added to it while stirring the slurry thoroughly. The stirring of the slurry was continued under continuous nitrogen flow for about an hour before it was centrifuged and washed twice. The obtained LDH with the desired anion was then dried in a large watch glass in the hot air oven at a temperature of 70° C., ground and stored for analysis.

To prepare the nickel doped samples, in which a small amount of nickel was incorporated into the LDH, a solution of nickel chloride which was equimolar to the Al in LDH was added to the LDH of the required anion dispersed in water. This mixture was also stirred for an hour and then centrifuged and washed twice before it was dried and stored.

In all cases, the presence of incorporated sulfonate anion was demonstrated by infrared spectroscopy of the products, and further demonstrated, as was the LDH nature of the materials, by powder x-ray diffraction. Uptake of nickel was demonstrated by colour change and by elemental analysis.

### Preparation of 2:1 Mg—Al CBS, and Subsequent Incorporation of Nickel

To prepare 2:1 Mg—Al LDH-CBS, 19.42 g para-chlorobenzene sulfonic acid (90.5 mmol, Aldrich) was suspended in 500 mL of deionized water, then stirred until completely dispersed. This solution was neutralized with 4.7 mL of 50% NaOH, and then added to a 5000 mL three-necked roundbottomed flask, containing the 2:1 Mg—Al LDH-NO₃ precipitate (stirring in 500 mL of deionized water, under a nitrogen blanket). For 2:1 Zn—Al LDH-CBS, 14.96 g CBS (69.7 mmol, acid-form, Aldrich) was suspended in 500 mL of deionized water, and stirred until completely dispersed. This solution was neutralized with 3.6 mL of 50% NaOH, and then added to a different 5000 mL three-necked roundbottomed flask, containing the 2:1 Zn—Al LDH-NO₃ precipitate (stirring in 500 mL of deionized water, under a nitrogen blanket). The resulting suspensions were allowed to stir for one hour, then removed for separation and washing, as previously described. The final products were recovered through Biichner filtration, washed with methanol, and then dried in an oven at 70° C.

### Nickel Loading of LDH-CBS

For the materials to be treated with nickel, different 25 g batches of 2:1 Mg—Al or 2:1 Zn—Al LDH-NO₃ were prepared, then exchanged with deprotonated CBS, and separated and washed, as described above. They were placed back in their respective 5000 mL three-necked roundbottomed flasks, along with 500 mL of deionized water. For the 2:1 Mg—Al LDH-CBS sample, 21.52 g of NiCl₂.6H₂O (90.5 mmol, Alfa Aesar) was dissolved in 100 mL of deionized water, then added to the LDH suspension. For the 2:1 Zn—Al LDH-CBS sample, 16.57 g of NiCl₂.6H₂O (69.7 mmol, Alfa Aesar) was dissolved in 100 mL of deionized water, then added to the LDH suspension. Both of these LDH suspensions were allowed to stir for one hour, then removed for separation and washing, as previously described. The final products were also recovered through Büchner filtration, washed with methanol, and then dried in an oven at 70° C.

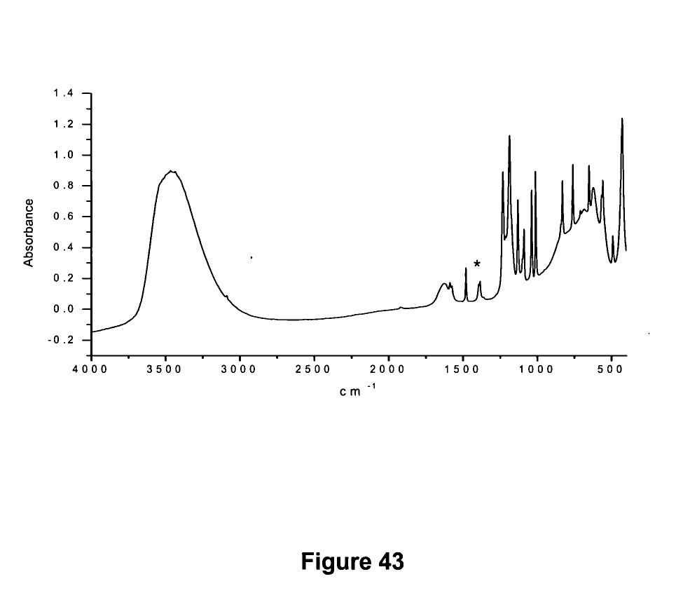

FIG. 43 shows an FTIR spectrum of 2:1 Zn—Al LDH 4-chlorobenzenesulfonate. The trace quantity of residual nitrate is indicated by the asterisk (*). Note the presence of peaks characteristic of LDH, and of the sulfonate and organic groupings present in the incorporated organic anion.

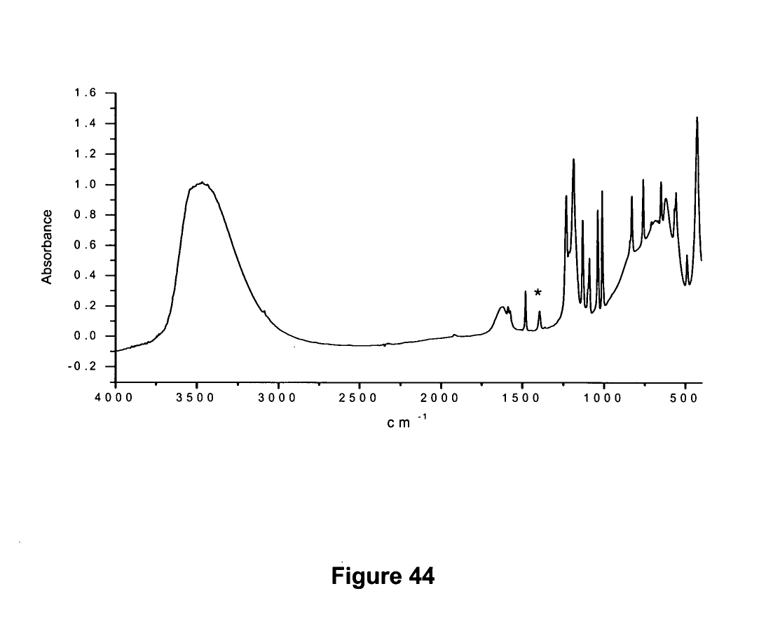

FIG. 44 shows an FTIR spectrum of 2:1 Zn—Al LDH 4-chlorobenzenesulfonate after treatment with nickel. Residual nitrate is again indicated by the asterisk (*). Note close similarity to FIG. 43.

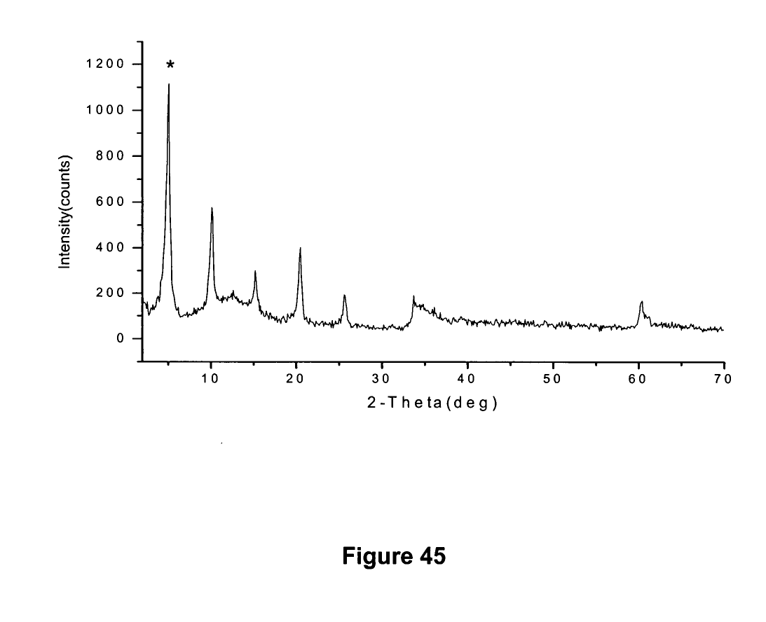

FIG. 45 shows an XRD pattern of 2:1 Zn—Al LDH 4-chlorobenzenesulfonate. The basal spacing is indicated by the asterisk (*). The presence of large basal spacing and overtones, and of spacing around 62°, are all characteristic of well crystalline LDH incorporating a large organic anion.

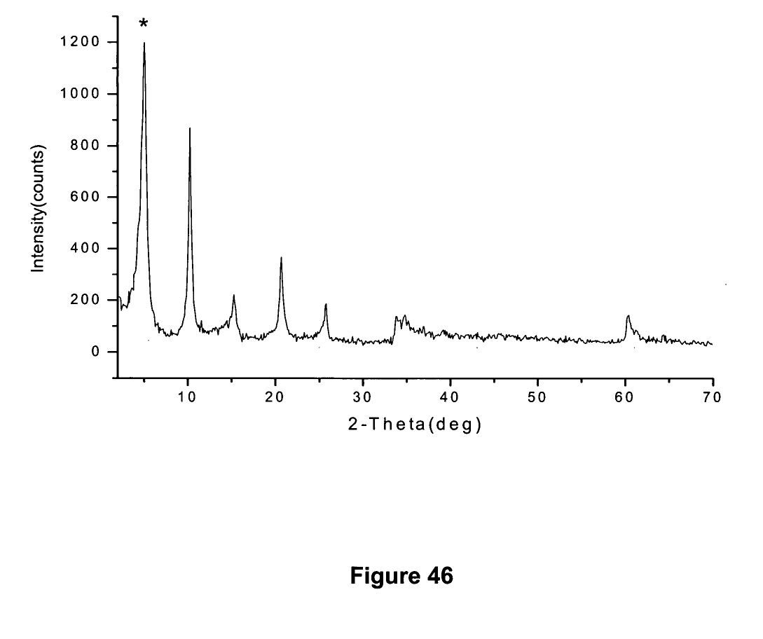

FIG. 46 shows an XRD pattern of 2:1 Zn—Al LDH 4-chlorobenzenesulfonate with nickel. The basal spacing is again indicated by the asterisk (*). There is close similarity to FIG. 45, showing that uptake of nickel has not led to major structural changes.

### Example 4

The LDH described in this application can be compounded by any polymer processing route. Examples include extrusion, injection molding, solutions, or other types of processing. Compounded materials could be used in any form, such as films, fibers, sheets, foams and others.

In one example, the LDH described herein can be compounded with poly(ethylene terephthalate) (PET). The LDH has been combined with PET at LDH:PET ratios of greater than 0.5. Flame retardant properties were observed for this material.

LDH has also been combined with PET at a wt % of 3%. Flame retardant properties were also observed for this material. LDH could be combined with PET at a wt % of between 0.1% and 99%.

Weight percent (“wt %”) as used herein refers to the weight of the added compound as a percentage of the total weight of the mixture or combination. For example, if 1 gram of component A was added to component B to form 100 g of combination C, component A could be said to be present at 1 wt %.

UL_{—}94 tests were conducted to investigate the flame retarding capability of the LDH, and compared with pure PET. This test is based on the measurement of the time it takes for a flame to self-extinguish in a controlled environment (the UL-94 chamber). The LDH materials improved the quench time compared to pure PET samples as shown in Table 18 below.

TABLE 18

| | | | T1 + T2 |
|---|---|---|---|
| Material | T1 | T2 | (seconds) |
| Pure PET | 22.4 | 16.24 | 38.64 |
| PET + 3 wt % Zn Al LDH sulfanilate | 12.38 | 4 | 15.25 |
| PET + 5 wt % Mg Al LDH Sulfanilate | 16.4 | 2.5 | 17.4 |
| PET + 5 wt % Mg Al LDH Sulfanilate-Ni | 16.67 | 11.73 | 23.7 |
| PET + 5 wt % Zn Al Sulfanilate | 7.7 | 5.66 | 13.34 |
| PET + 5 wt % Zn Al Sulfanilate-Ni | 9.04 | 10.9 | 21.2 |
| PET + 5 wt % Mg Al CBS | 8.56 | 0 | 4.5 |
| PET + 5 wt % Mg Al CBS-Ni | 8.94 | 1 | 9.68 |
| PET + 5 wt % Zn Al CBS | 8 | 1.5 | 5.25 |
| PET + 5 wt % Zn Al LDH CBS-Ni | 7 | 0 | 7 |
| PET + 5 wt % Mg Al PTS | 5.94 | 0 | 8 |
| PET + 5 wt % Mg Al PTS-Ni | 7.23 | 1 | 6.03 |
| PET + 5 wt % Zn Al PTS | 9.3 | 0 | 9.3 |
| PET + 5 wt % Zn Al PTS Ni | 4.85 | 0 | 4.9 |

Samples of PET+3 wt % Zn Al LDH sulfanilate were burned and the results examined. The needle shape at the tip of each sample indicated that the LDH formed an insulative barrier which limited the permeation of oxygen through the sample and thus quenched the flame.

### REFERENCES CITED

The following references, to the extent that they provide exemplary procedural or other details supplementary to those set forth herein, are specifically incorporated herein by reference.

### REFERENCES

Allmann, R. Am. Mineral. 1968, 53, 1057.
Beekman, S. M. J. Am. Pharm. Assoc. 1960, 49, 191.
Bellotto, M.; Rebours, B.; Clause, O.; Lynch, J.; Bazin, D.; Elkaiem, E. J. Phys. Chem. 1996, 100, 8527.
Besserguenev, A. V.; Fogg, A. M.; Francis, R. J.; Price, S. J.; Isupov, V. P.; Tolochko, B. P.; O'Hare, D. Chem. Mater. 1997, 9, 241.
Bhattacharyya, A.; Chang, V. W.; Schumacher, D. J. Appl. Clay Science 1998, 13, 317
Boclair, J. W.; Brister, B. D.; Jiang, J.; S. Lou, S.; Wang, Z.; Yarberry, F.; Braterman, P. S. Origins of Life Evol. Biosphere 2001, 31, 53.
Bookin, A. S.; Cherkashin, V. I.; Drits, V. A. Clays Clay Miner. 1993, 41, 558.
Bookin, A. S.; Drits, V. A. Clays Clay Miner. 1993, 41, 551.
Braterman, P. S.; Xu, Z. P., Yarberry, F. In Handbook of Layered Materials; Auerbach, S. M., Carrado, K. A., Dutta, P. K., Eds; Marcel Dekker: New York, 2004; p 373.
Choy, J. H.; Kwak, S. Y.; Park, J. S.; Jeong, Y. J. J. Mater. Chem. 2001, 11, 1671.
Constantino, U.; Casciola, M.; Massinelli, L.; Nocchetti, M.; Vivani, R. Solid State Ionics 1997, 97, 203.
Constantino, V. R. L.; Pinnavaia, T. J. Inorg. Chem. 1995, 34, 883.
Corma, A.; Fornes, V.; Martinaranda, R. M.; Rey, F. J. Catal. 1992, 58, 134.
Crepaldi, E. L.; Pavan, P. C.; Valim, J. B. Chem. Comm. 1991, 155.
de A. A. Soler-Illia, G. J.; Candal, R. J.; Regazzoni, A. E.; Blesa, M. A. Chem. Mater. 1997, 9, 184.
de Roy, A.; Forano, C.; El Malki, K.; Besse, J. P. In Synthesis of Macroporous Materials; Occelli, M. L., Robson, H. E., Eds., Van Nostrand Reinhold: New York, 1992; Vol. 2, p 108.
Feichnecht, W.; Gerber, M. Helv. Chim. Acta 1942, 25, 131.
Finta, Z.; Hell, Z.; Balan, D.; Cwik, A.; Kemeny, S.; Figueras, F. J. Molec. Catal. A: Chem. 2000, 161, 149.
Fisher, H. R.; Geilgens, L. H. Nanocomposite Material. U.S. Pat. No. 6,372,837, Apr. 2, 2002.
Flink, G. Arkiv Kemi. Min. Geol. 1910, 3, 1.
Flink, G. Z. Kryst. Min. 1914, 53, 409.
Gordijo, C. R.; Barbosa, C. A. S.; Ferreira, A. M. D.; Contantino, V. R. L.; Silva, D. D. O. J. Pharm. Sci. 2005, 94, 1135.
Hermosin, M C, Pavlovic, I., Ulibarri, M A, Cornejo, J. J. Environ. Sci. Health 1993, A28, 875.
Hoffmeister, W.; von Platen, H. Cryst. Rev. 1992, 3, 3.
Ingram, L.; Taylor, H. F. W. Mineral Mag. 1967, 36, 465.
Itaya, K.; Chang, H. C.; Uchida, I. Inorg. Chem. 1987, 26, 624.
Iyi, N.; Maksumoto, T.; Kaneko, Y.; Kitamura, K. Chem. Lett. 2004, 33, 1122.
Johnson, T. E.; Martens, W.; Frost, R. L.; Ding, Z.; Kloprogge, J. T. J. Raman. Spectrosc. 2002, 33, 604.
Kang, M. J.; Rhee, S. W.; Moon, H.; Neck, V.; Fanghanel, T. Radiochimica Acta 1996, 75, 169.
Lakraimi, Mohamed; Legrouri, Ahmed; Barroug, Allal; De Roy, Andre; Besse, Jean Pierre. Materials Research Bulletin 2006 41(9):1763-1774.
Laycock, D. E.; Collacott, R. J.; Skelton, D. A.; Tchir, M. F. J. Catal. 1991, 130, 354.
Layered Double Hydroxides: Present and Future; Rives, V., Ed.; Nova Science Publishers: Huntington, New York, 2001.
Lopez, T.; Bosch, P.; Ramos, E.; Gomez, R.; Novaro, O.; Acosta, D.; Figueras, F. Langmuir 1996, 12, 189.
Lowenstein, W. Am. Mineral. 1954, 39, 92.
Mascolo, G.; Marino, O. Mineralogical Magazine 1980, 43, 619.
Miyata, S. Clays Clay Miner. 1983, 31, 305.
Miyata, S.; Kamura, T. Chem. Lett. 1973, 843.
Miyata, S.; Kuroda, M. U.S. Pat. No. 4,299,759, Nov. 10, 1981
Mortland, M. M.; Gastuche, M. C. Compt. Rend. 1962, 225, 2131.
Nayak, M.; Kutty, T. R. N.; Jayaraman, V.; Periaswamy, G. J. Mater. Chem. 1997, 7, 2131.
Newman, S. P.; Jones, W.; O'Connor, P.; Stamires, E. N. J. Mater. Chem. 2002, 12, 153.
Ogawa, M.; Asai, S. Chem. Mater. 2000, 12, 3253.
Ona-Nguema, G.; Abdelmoula, M.; Joran, F. Environ. Sci. Technol. 2002, 36, 16.
Padmasri, A. H.; Venugopal, A.; Kumari, V. D.; Rama Rao, K. S.; Kanta Rao, P. J. Molec. Catal. A: Chem. 2002, 188, 255.
Pauling, L. The Nature of the Chemical Bond. 3rd ed: Cornell University Press, New York, 1960.
Peppley, B. A.; Amphlett, J. C.; Kearns, L. M.; Mann, R. F. App. Catal. A: General 1999, 179, 21.
Pitsch, S.; Eschenmoser, A.; Gedulin, B.; Hui, S.; Arrhenius, G. Origins Life Evol. Biosphere 1995, 25, 294.
Qiu, J. B.; Villemure, G. J. Electroanal. Chem. 1997, 428, 165.
Rius, J.; Allmann, R. Z. Kristallog. 1984, 168, 133.
Rives, V.; Kannan, S. J. Mater. Chem. 2000, 10, 489.
Robins, D. S.; Dutta, P. K. Langmuir 1996, 12, 402.
Roelofs, J. C. A. A.; van Dillen, A. J.; de Jong, K. P. Catal. Today 2000, 60, 297.
Ross, G. J.; Kodama, H. The Am. Mineral. 1967, 52, 1036.
S. Komarneni, N. Kozai and R. Roy, J. Mater. Chem. 1998 8, 1329-1331.
Serna, C. J.; Rendon, J. L.; Iglesias, J. E. Clays Clay Miner. 1982, 30, 180.
Soma, I.; Wakano, H.; Takahashi, H.; Yamaguchi, M. Flame-Resistant Vinyl Chloride Resin Compositions. Jap. Patent 50,063,047, May 29, 1975
Song, Y.; Moon, H. S. Clay Miner. 1998, 33, 285.
Suzuki, E.; Ono, Y. Bull. Chem. Soc. Jpn. 1988, 61, 1008.
Taylor, H. F. W. Miner. Mag. 1973, 37, 338.
Treadwell, W. D.; Bernasconi, E. Hely. Chim. Acta 1930, 13, 500.
Trifio, F.; Vaccari, A. in Comprehensive Supramolecular Chemistry; Atwood, J. L., Manicol, D. D., Davies, J. E. D., Vogtle, F., Eds.; Pergamon: Oxford, 1996; Vol. 7, p 251. Ulibarri, M. A.; Hernandez, M. J.; Cornejo, J. J. Mater. Sci. 1991, 26, 1512.
van Oosterwyck-Gastuche, M. C.; Brown, G.; Mortland, M. M. Clay Miner. 1967, 7, 177.
Yarberry, F. Layered Double Hydroxides via Aluminate. Ph.D. Dissertation, University of North Texas, Denton, Tex., 2002.
Zammarano, M.; Massimiliano, F.; Bellayer, S.; Gilman, J. W.; Meriani, S. Polymer 2005, 46, 9314.

What is claimed:

1. A method for producing a layered double hydroxide (LDH), comprising the steps of
a) dissolving a soluble metal salt or a mixture of soluble metal salts in water to give a metal salt solution;
b) precipitating the metal salt solution and washing it to give an LDH;
c) adding a solution of a sulfonic acid salt, or sulfonic acid together with base, to the LDH to give an LDH sulfonate suspension; and
d) stirring, separating, and washing the LDH sulfonate suspension to give an LDH with exchanged anion,
wherein the metal salt solution is heated after dissolving.

2. (canceled)

3. The method of claim 1, wherein the metal salt solution is precipitated using NaOH.

4. The method of claim 1, wherein the metal salt comprises a cation selected from the group consisting of Ni²⁺, CO²⁺, Zn²⁺, Fe²⁺, Mn²⁺, Cu²⁺, Ti²⁺, Cd²⁺, Pd²⁺, Ca²⁺, Al³⁺, Ga³⁺, Fe³⁺, Cr³⁺, Mn³⁺, Co³⁺, V³⁺, In³⁺, Y³⁺, La³⁺, Rh³⁺, Ru³⁺, Sc³⁺, and a combination thereof.

5. The method of claim 1, wherein the sulfonic acid is sulfanilic acid.

6. The method of claim 1, wherein the sulfonic acid is p-toluenesulfonic acid.

7. The method of claim 1, wherein the sulfonic acid is 4-chlorobenzenesulfonic acid.

8. The method of claim 1, wherein the LDH sulfonate suspension is separated by centrifuge.

9. A method for producing a metal-doped layered double hydroxide (LDH), comprising the steps of:
a) dissolving a trivalent or divalent soluble metal salt, or a mixture thereof, in water to give a metal salt solution;
b) adding a base to give an LDH containing the anion or anions present in the above salt solution and/or hydroxide or carbonate anions;
c) adding a sulfonic acid salt, or sulfonic acid in the presence of base, to the LDH to give a sulfonate-containing LDH; and
d) combining the sulfonate-containing LDH with a solution of a dopant metal salt or compound to give a metal-doped layered double hydroxide.

10. The method of claim 9, further comprising the step of stirring, separating and washing the sulfonate-containing LDH before combining the sulfonate-containing LDH solution with the solution of dopant metal salt or compound.

11. The method of claim 9, wherein the dopant metal salt is a nickel salt.

12. The method of claim 9, further comprising the step of ageing the LDH by allowing it to stand.

13. The method of claim 9, further comprising the step of ageing the LDH by heating.

14. The method of claim 9, further comprising the step of washing the LDH before treatment with sulfonate.

15. The method of claim 9, wherein the metal salt solution is precipitated using dissolved hydroxide or a source of hydroxide.

16. The method of claim 9, wherein the metal salt comprises a cation selected from the group consisting of Ni²⁺, Co²⁺, Zn²⁺, Fe²⁺, Mn²⁺, Cu²⁺, Ti²⁺, Cd²⁺, Pd²⁺, ca²⁺, Al³⁺, Ga³⁺, Fe³⁺, Cr³⁺, Mn³⁺, Co³⁺, V³⁺, In³⁺, Y³⁺, La³⁺, Rh³⁺, Ru³⁺, Sc³⁺, and a combination thereof.

17. The method of claim 9, wherein the sulfonic acid salt is a salt of sulfanilic acid.

18. The method of claim 9, wherein the sulfonic acid salt is a salt of p-toluenesulfonic acid.

19. The method of claim 9, wherein the sulfonic acid salt is a salt of 4-chlorobenzenesulfonic acid.

20. The method of claim 9, wherein the LDH is separated by centrifugation.

21. A composition comprising a layered double hydroxide with the general formula:
[M^{(II)}_{1-x-y}Ni^{(II)}_{y}M^{(III)}ₓ(OH)₂]^{x+}(A^{m-})_{x/m}.nH₂O
wherein A^{m-} represents an exchangeable anion, M^{(II)} represents a divalent cation; M^{(III)} represents a trivalent cation; Ni^{(II)} represents nickel ion; and wherein x is in the range of about 0.25 to 0.33, y is in the range of 1 to 1-x, and m is a whole number in the range of about 1 to 4, and wherein n is a positive number, commonly integer, or zero.

22. A composition as in claim 21, where A^{m-} is an organic sulfate or sulfonate.

23. A composition as in claim 21, where A^{m-} is an aromatic sulfonate.

24. A composition as in claim 21, where A^{m-} is a benzenesulfonate.

25. A composition as in claim 21, where A^{m-} is a benzenesulfonate with one or more alkyl, aryl, halide or amino group substituents.

26. A composition as described in claim 21, wherein the LDH has been exposed to a solution containing nickel.

27. A composition as described in claim 21, where the LDH has been aged by allowing it to stand or by heating prior to exposure to a solution containing the nickel.

28. A composition as described in claim 27, where the incorporation of nickel has not disrupted the pre-existing LDH lattice.

29. A composition as described in claim 21, wherein the LDH has been exposed to a divalent transition metal.

30. A composition as described in claim 21, wherein M^{(II)} is a transition metal.

31. The composition of claim 21, wherein A^{m-} is an exchangeable anion selected from the group consisting of NO₃⁻, Cl⁻, CO₃²⁻, SO₄²⁻, an organic carboxylate, a sulfate, a sulfonate, and a combination thereof.

32. The composition of claim 21, wherein M^{(II)} is selected from the group consisting of Mg²⁺, Ni²⁺, Co²⁺, Zn²⁺, Fe²⁺, Mn²⁺, Cu²⁺, Ti²⁺ (163), Cd²⁺, Pd²⁺, and Ca²⁺.

33. The composition of claim 21, wherein M^{(II)} is selected from the group consisting of Al³⁺, Ga³⁺, Fe³⁺, Cr³⁺, Mn³⁺, Co³⁺, V³⁺, In³⁺, Y³⁺, La³⁺, Rh³⁺, Ru³⁺, and Sc³⁺.

34. The composition of claim 21, wherein A^{m-} is sulfonate.

35. The composition of claim 21, wherein A^{m-} is sulfonate with substituted amine.

36. The composition of claim 21, wherein A^{m-} is sulfonate with a substituted alkyl or other organic group.

37. The composition of claim 21, wherein A^{m-} is sulfonate with substituted halide.

38. The composition of claim 21, wherein greater than or equal to 1% of the divalent metal has been replaced by nickel.

39. The composition of claim 21, wherein the ratio of nickel to total compound (w/w) is in the range of approximately 0.1% to 30%.

40. A composition comprising:
the composition of claim 21; and
poly(ethylene terephthalate).

41. The composition of claim 40, wherein the final concentration of LDH in poly(ethylene terephthalate) is about 0.1 to 99 wt %.

42. The composition of claim 40, wherein the final concentration of LDH in poly(ethylene terephthalate) is about 3 to 10 wt %.

43. (canceled)

44. (canceled)

45. (canceled)
